(19) United States
(12) Patent Application Publication
(10) Pub. No.: US 2014/0351045 A1
(43) Pub. Date: Nov. 27, 2014

(54) System and Method for Pairing Media Content with Branded Content

(71) Applicant: LNO (Official.fm) SA, Geneva (CH)

(72) Inventors: Jeremie Abihssira, Geneva (CH); Nicolas Daniel Scaringella, Geneva (CH); Loic Jean-Marie Burtin, Geneva (CH)

(21) Appl. No.: 13/901,925

(22) Filed: May 24, 2013

Related U.S. Application Data
(60) Provisional application No. 61/826,689, filed on May 23, 2013.

(51) Int. Cl. G06Q 30/02

(52) U.S. Cl. CPC G06Q 30/0255
USPC 705/14.53

(57) ABSTRACT

Systems and methods for pairing media content with branded content are described herein. The disclosed systems and methods describe a brandable media format that permits consumers to consume media content and branded content in manners that target the desires of consumers, media content owners, and brand owners. The branded content can be dynamically paired with the media content based on a number of factors. The brandable content can also be presented to the consumer in an non-intrusive way while the consumer consumes the media content with which the branded content is paired.

### CROSS-REFERENCE AND PRIORITY CLAIM TO RELATED APPLICATIONS

This patent application claims priority to provisional U.S. patent application Ser. No. 61/826,689, filed May 23, 2013, and entitled “System and Method for Pairing Media Content with Branded Content,” the entire disclosure of which is expressly incorporated herein by reference.

### INTRODUCTION

When breakthroughs in audio and video compression technologies merged with the high speed Internet, data of all kinds became available to the public in large quantities. Most people can readily access all kinds of information without taking a single step out of their home. However, due to the immense quantity of information flooded through the Internet, it can become difficult for consumers to find information that is of actual interest to them. In addition, advertisers have also been affected by the influx of information in the Internet world and the consumer fragmentation it causes because it has become more difficult for advertisers to easily find large groups of consumers to effectively target and reach for advertising.

As consumers tend to consume more and more media content, such as music, through the Internet, advertisers are now more interested in advertising their products or goods through media distribution channels. Likewise, media content owners must now develop a plan for promoting their artistic works through electronic media distribution channels (such as over the Internet). However, consumers tend to be resistant to intrusive advertisements that are distributed over the Internet. Thus, it is believed that there is a significant need in the art for more convenient and effective ways for brand owners and media content owners to cooperatively target their potential consumers, but at the same time, not discourage consumers from purchasing their products because of intrusive advertising.

In an effort to satisfy such perceived needs in the art, the inventors disclose various methods, systems, apparatuses, and computer program products for rendering media content brandable in a flexible and non-intrusive manner.

For example, according to an exemplary embodiment, the inventors disclose a method for pairing media content with branded content, the method comprising: (1) storing a media content item in a memory, the media content item configured to be played for a user via a digital media player, the media content item comprising (i) playable media content configured for playback to a user, and (ii) metadata about the playable media content, (2) determining a branded content item for pairing with the playable media content based on the metadata, (3) playing the playable media content via the digital media player, (4) playing the determined branded content via the digital media player without interrupting the playing of the playable media content, and wherein the method steps are performed by a processor.

Examples of media content can include audio works (e.g., musical works such as songs, etc.), image or video works (e.g., photographs, slideshows, etc.), and audio/video works (e.g., movies, music videos, television shows, video games, etc.). Furthermore, as used herein, the term “branded content” refers to content that displays, invokes, or otherwise communicates a particular brand, for which branding revenue or other consideration is generated from a brand owner or other third party. It should be understood that the term “branded content” would not encompass an item that is being used by a media content owner to promote his or her own media content, which would not necessarily require the media content owner to pay or provide other consideration for such promotion. For example, if the media content in question is a song by the band The Rolling Stones, an album cover image for the Rolling Stones album that includes the song in question, or other Rolling Stones-related materials such as the Hot Lips logo used by the band would not qualify as “branded content” as those items are merely self-promoting the media content of The Rolling Stones. In contrast, a third party advertisement featuring a song by The Rolling Stones (e.g., a Mercedes commercial featuring a song by The Rolling Stones) would qualify as “branded content,” as it generates branding revenue from a third party brand owner. An example of “branded content” is an advertisement. As used herein, an “advertisement” refers to a promotional item for which advertising revenue is generated from an advertiser. In an exemplary embodiment where the media content comprises a musical work, it is preferred that the branded content take the form of an image so as to not intrude on the user's experience of consuming the musical work. However, it should be understood that the branded content can take other forms. For example, in accordance with exemplary embodiments described herein, the branded content that is paired with media content such as a musical work can take the form of a branded video game. Thus, as the user listens to the musical work through his or her computing device, he or she can also choose to play the video game via the computing device. In another embodiment, the media content can comprise a video work. In such an embodiment, it is preferred that the branded content take the form of audio or music so as to not intrude on the user's experience of consuming the video work. In either exemplary embodiment, whether the media content comprises a musical work or a video work, the branded content can be configured to take an appropriate form of work such that the user can consume both media content and branded content simultaneously without interruption.

The inventors also disclose an apparatus for pairing media content with branded content, the apparatus comprising a processor configured to (1) store a media content item in a memory, the media content item configured to be played for a user via a digital media player, the media content item comprising (i) playable media content configured for playback to a user, and (ii) metadata about the playable media content, (2) determine a branded content item for pairing with the playable media content based on the metadata, (3) play the playable media content via the digital media player, and (4) play the determined branded content via the digital media player without interrupting the playing of the playable media content.

Further still, the inventors disclose a computer program product for pairing content with branded content, the computer program product comprising a plurality of instructions resident on a non-transitory computer-readable storage medium and executable by a processor to (1) store a media content item in a memory, the media content item configured to be played for a user via a digital media player, the media content item comprising (i) playable media content configured for playback to a user, and (ii) metadata about the playable media content, (2) determine a branded content item for pairing with the playable media content based on the metadata, (3) play the playable media content via the digital media player, and (4) play the determined branded content via the digital media player without interrupting the playing of the playable media content.

In accordance with additional exemplary aspects described herein, the inventors also disclose a media content product comprising a computer-readable data structure that is resident on a non-transitory computer-readable storage medium, the data structure comprising (1) media content configured for playback through a digital media player, (2) metadata about the media content, the metadata including an image, and (3) executable program code configured, upon execution, to (i) call a remote server over a network, (ii) receive a branded content item from the remote server in response to the call, and (iii) cause the digital media player to visually display, during a playback of the media content, the image and the branded content item in an alternating sequence.

The inventors also disclose an apparatus comprising a processing device configured to execute a digital media player, the processing device including a display screen, wherein the digital media player is configured to (1) play media content in response to user input, (2) send a message to a remote server over a network, the message including metadata about the media content, (3) receive a branded content item from the remote server in response to the message, and (4) cause the digital media player to also play the branded content item without interrupting the playing of the media content.

In accordance with yet another exemplary embodiment described herein, the inventors also disclose an apparatus comprising a server for communication over a network with a remote digital media player, the server configured to (1) receive metadata about media content from the digital media player over the network after the media content has been selected for play through the digital media player, (2) select a branded content item from a plurality of branded content items based on the received metadata, and (3) communicate the selected branded content item over the network to the digital media player to cause the digital media player to play the branded content item without interrupting the playing of the media content.

The inventors further disclose a system for pairing media content with branded content, the system comprising: (1) a memory, and (2) a server for access over a network by a plurality of remote computers, the server configured to provide a plurality of interfaces for the remote computers to the memory, the interfaces including (a) a media content source interface, the media content source interface configured to receive (i) a plurality of media content items, (ii) metadata about the media content items, and (iii) a plurality of branding criteria for association with the media content items from a plurality of media content sources via a plurality of the remote computers, and (b) a branded content source interface, the branded content source interface configured to receive (i) a plurality of branded content items and (ii) a plurality of brand targeting criteria from a plurality of branded content sources via a plurality of the remote computers; wherein the server is further configured to store the received media content items in the memory in association with (i) data indicative of their respective media content sources, (ii) their respective received metadata, and (iii) their respective branding criteria; wherein the server is further configured to store the received branded content items in the memory in association with (i) data indicative of their respective branded content sources, (ii) their respective brand targeting criteria, and wherein the server is further configured to associate a plurality of the media content items in the memory with a plurality of the branded content items in the memory based on a correspondence between the branding criteria associated with the media content items and the brand targeting criteria associated with the branded content items.

In accordance with another exemplary aspect, the inventors disclose a method comprising: (1) providing a user interface configured to solicit input for defining a plurality of parameters for an auction of a branding right with respect to a media content item, and (2) creating an auction in accordance with solicited input. wherein the method steps are performed by a processor. The inventors further disclose corresponding apparatuses and computer program products.

The inventors also disclose a method comprising: (1) receiving a plurality of bids associated with a plurality of branded content items for a branding right with respect to a media content item, (2) processing bids to identify a winning bid, and (3) creating a pairing association between the branded content item associated with the winning bid and the media content item such that the branded content item associated with the winning bid will be presented to a plurality of consumers when the media content item is consumed by the consumers, and wherein the method steps are performed by a processor. The inventors further disclose corresponding apparatuses and computer program products.

In accordance with another exemplary aspect, the inventors disclose a method comprising: (1) receiving data indicative of a selection of a song for playback to a user through a computer, (2) selecting a video game based on the received data, and (3) communicating an image of the selected video game to the computer to cause the computer to display the image while the song is played through the computer, and wherein the method steps are performed by a processor. The inventors further disclose corresponding apparatuses and computer program products.

Still further, the inventors disclose a method comprising: (1) receiving data indicative of a selection of a video work for playback to a user through a computer, (2) selecting audio branded content based on the received data, and (3) communicating the selected audio branded content to the computer to cause the computer to play the selected audio branded content while the video work is played through the computer, and wherein the method steps are performed by a processor. The inventors also disclose corresponding apparatuses and computer program products.

In accordance with still another exemplary aspect, the inventors disclose a method comprising: (1) receiving data indicative of a selection of a song for playback to a user through a computer, (2) selecting a branded content item based on the received data, and (3) communicating an image puzzle corresponding to the selected branded content item to the computer to cause the computer to display the image puzzle while the song is played through the computer, the image puzzle comprising a plurality of image portions that are presented in a puzzled format, the image portions being movable in response to user input to present the branded content item as an unpuzzled image, and wherein the method steps are performed by a processor. The inventors further disclose corresponding apparatuses and computer program products.

Exemplary embodiments described herein may thus serve to provide media content owners and brand owners with a brandable media format to help them locate and target groups of consumers effectively and conveniently. The branded content can be dynamically paired with media content based on the content of the media content itself, profiled information about the users, and/or the users' locations so that users can consume advertisements that are more likely to be of interest to the them. This dynamic pairing feature also provides an alternative revenue source for owners of media content beyond simple content purchase models. In addition, because a brandable media format as described herein can be played without being intrusive to the user, it need not inhibit, impair, or delay the users' consumption of media content.

These and other features and advantages of the present invention will be apparent to those having ordinary skill in the art upon review of the teachings in the following description and drawings.

### BRIEF DESCRIPTION OF THE DRAWINGS

FIG. 1 illustrates a schematic block diagram of a system according to an exemplary embodiment.

FIG. 2A illustrates a structure of a media database according to an exemplary embodiment.

FIG. 2B illustrates a structure of a brand database according to an exemplary embodiment.

FIG. 3A illustrates a structure of a geo-localisation database according to an exemplary embodiment.

FIG. 3B illustrates a structure of an IP-geolocalisation database according to an exemplary embodiment.

FIG. 4 illustrates a structure of a user information database according to an exemplary embodiment.

FIG. 5A illustrates a display of a media background rendered as a media player on a desktop computer according to an embodiment.

FIG. 5B illustrates a display of a media background rendered as a media player on a mobile device according to an embodiment.

FIG. 6 illustrates a display of a social networking website embedding brandable media according to an embodiment.

FIG. 7 illustrates a display screen of a computing device showing a user interface for a user's playlist according to an embodiment.

FIG. 8 illustrates a display screen of a computing device showing a user interface for a “More Music” link according to an embodiment.

FIG. 9 illustrates a display screen of a computing device showing a user interface for a “Comments” link according to an embodiment.

FIG. 10 illustrates a display of a brand background rendered as a media player on a desktop computer according to an embodiment.

FIG. 11 illustrates a display of a brand background rendered as a vintage car game according to an embodiment.

FIG. 12 illustrates a display of a brand background rendered as a puzzle game according to an embodiment.

FIG. 13 illustrates a display screen of a computing device showing a user interface for searching media contents according to an embodiment.

FIG. 14A illustrates a display screen of a computing device showing two branded backgrounds according to an embodiment.

FIG. 14B illustrates a display screen of a computing device showing three branded backgrounds according to an embodiment.

FIG. 15 illustrates a display screen of a computing device showing a user interface for chatting according to an embodiment.

FIGS. 16A-C illustrate exemplary aspects of a bidding mechanism for pairing branded content with media content.

### DETAILED DESCRIPTION

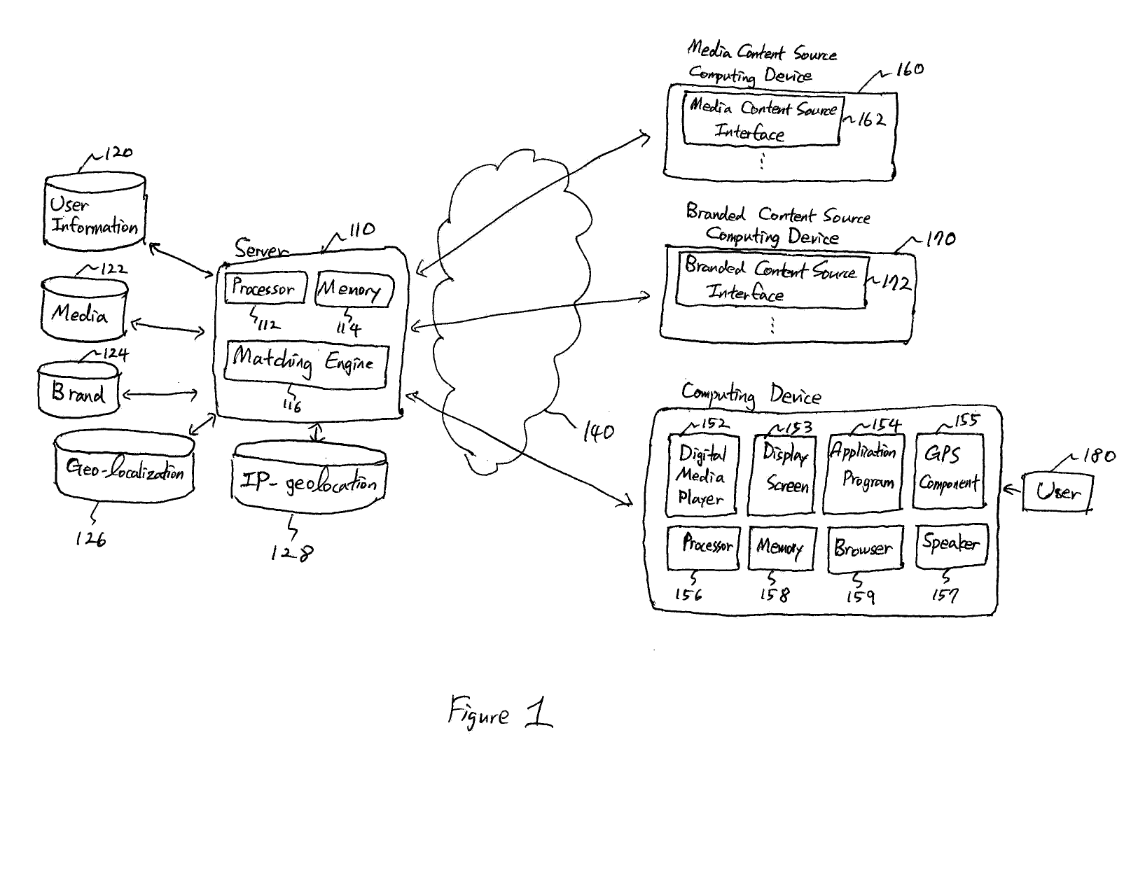

FIG. 1 is a schematic block diagram of an exemplary system for an exemplary embodiment. The exemplary system of FIG. 1 may include a server 110 for communication over a network 140 with one or more consumer computing devices 150. The server 110 may also be configured for communication over network 140 with one or more media content source computers 160 and branded content source computers 170. As shown by FIG. 1, the server 110 may have access to a user information database 120, a media database 122, a brand database 124, a geo-localization database 126, and an IP-geolocation database 128. The server 110 may include a processor 112, a memory 114, and a matching engine 116 for execution by the processor.

Users such as media consumers 180 can access the server 110 via computing devices 150 to gain access to media content and branded content. The computing device 150 may include a digital media player 152, a visual display capability 153 (such as a display screen), an application program 154, a global positioning system (GPS) component 155, a processor 156, a speaker 157, a memory 158, and a browser application 159. However, it should be understood that different configured computing devices can be employed. The computing device 150 can be any device with sufficient computational and network-connectivity capabilities to interface with the server 110 for the purposes described herein. For example, the computing device 150 can be a mobile device such as a smartphone (e.g., iPhone, a Google Android device, a BlackBerry device, etc.), tablet computer (e.g., iPad), or the like. The computing device 150 can also take forms such as a personal computer (e.g., a desktop computer or laptop computer). The processor 156 and memory 158 of the computing device 150 can be configured to cooperate to execute software and/or firmware that supports functionalities such as the digital media player 152, browser 159, application program 154, etc.

The computing devices 160 and 170 can take similar forms to that of computing device 150. The media content source computing device 160 can be configured to interface a media content source such as a media content owner with the server 110 (e.g., via an interface 162). The branded content source computing device 170 can be configured to interface a branded content source such as a brand owner with the server 110 (e.g., via an interface 172).

The network 140 can be any data communications network capable of communicating data between the server 110 and any of the computing devices 150, 160, and 170. An example of a suitable network is the Internet. However, it should be understood that the network 140 can comprise a plurality of networks that interconnect to form a larger network, including networks such as cellular data networks and other wireless or wired data networks.

The server 110 can be any computer with sufficient computational and network-connectivity capabilities to interface with the computing devices 150, 160, and 170 via network 140. The processor 112 and the memory 114 can be configured to cooperate to execute software and/or firmware that supports one or more operations of the server 110 as set forth herein, such as the matching engine 116. It should be understood that the server 110 may comprise multiple servers. Furthermore, in an exemplary embodiment, one or more of the databases 120, 122, 124, 126, and 128 can be configured to be an internal database of the server 110 that resides on the server 110, or alternatively, can be configured to be an external database operated by a third party. Also, it should be understood that the databases 120, 122, 124, 126, and 128 can be consolidated on a single physical memory device or distributed across multiple physical memory devices, depending upon the desires of a practitioner.

As discussed below, the exemplary system is configured to serve as a brandable media format which enables consumers 180 to combine experiences of appreciating artistic work and branded content without interference. Because the branded content can rendered together with the media content in a manner such that the branding is not intrusive and does not interfere with the primary objective of the consumer 180 (which is to consume the media content), it is believed that the inventive system will serve the interests of media content owners, brand owners, and consumers.

In operation, the server 110 can be configured to provide interfaces to the computing devices 160 and 170 for interacting with the media database 122 and brand database 124. For security purposes, the server 110 can limit access to these interfaces based on login/password controls.

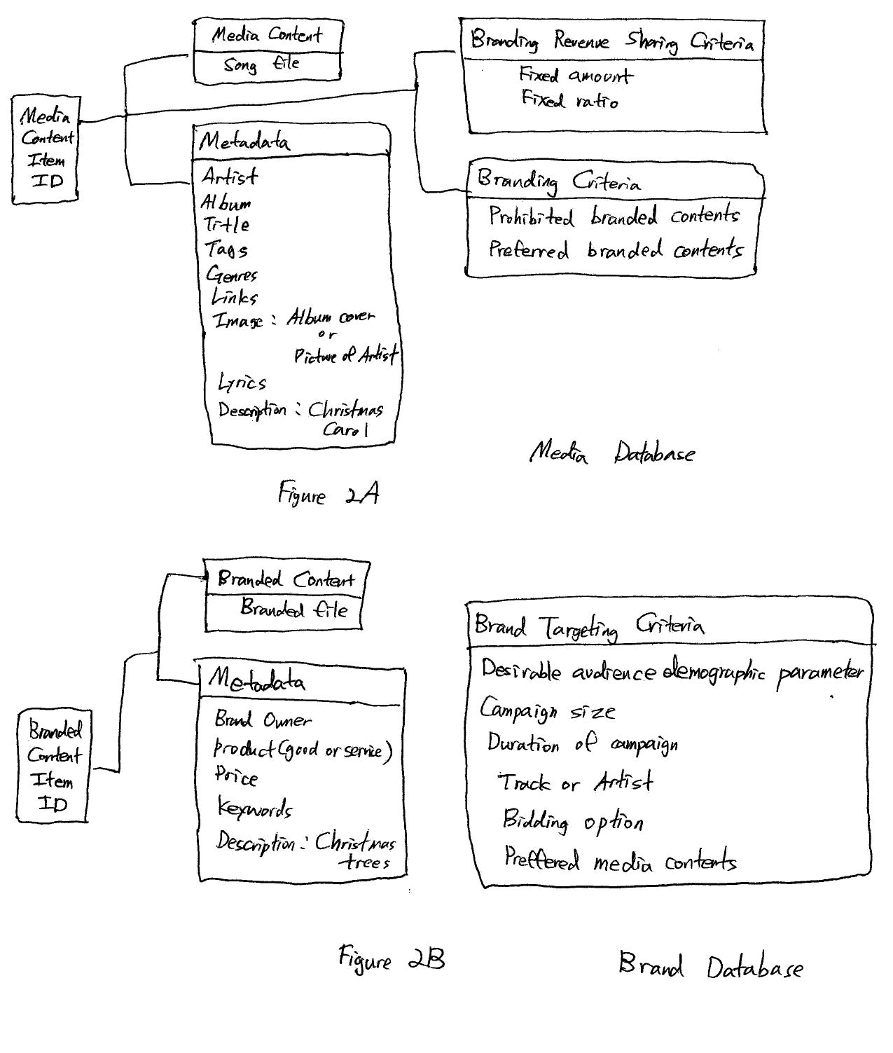

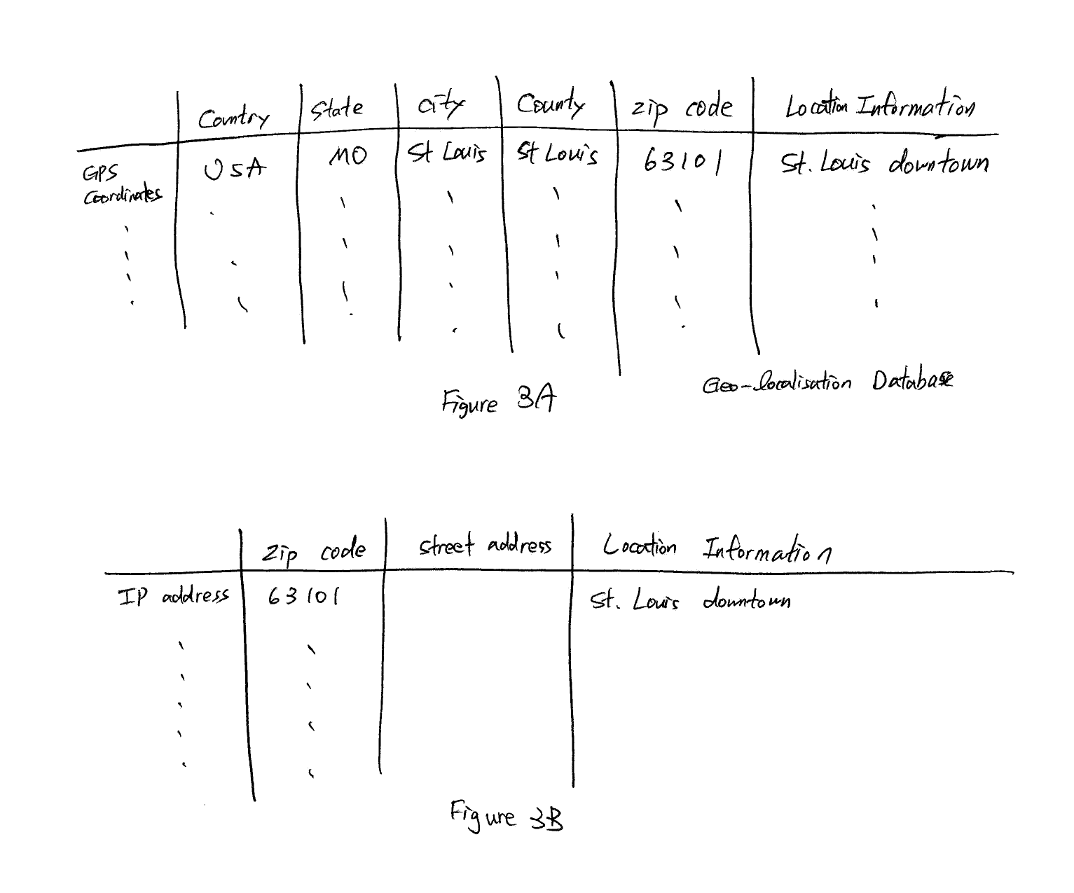

A media content source interface 162 can provide media content owners with an ability to upload media content and related information to the media database 122. This media content source interface can be configured as a web platform accessed via the server 110. A graphical user interface (GUI) can be presented on computing device 160, where this GUI is configured to solicit from the media content owner the playable media content itself (e.g., the actual media file that represents the playable media content) and the metadata (e.g., descriptions) of the playable media content. In turn, the server 110 can make an entry to the media database 122 for newly uploaded media content items to store the playable media content and associated metadata in the database 122. A discussion of the types of metadata that can be solicited is included below in connection with the description of FIG. 2A. For example, the GUI can be configured to permit a media content owner to specify a genre for the media content item or add other tags for the media content item to be used as part of the metadata of the media content.

The media content source interface can also be configured to receive control instructions from the media content owners for application to their media content. For example, each item of media content can be associated with branding criteria. Such branding criteria can define various instructions or information for controlling what branded content may later be paired with the media content. For example, a media content owner can select the types of branded content that are eligible to be paired with media content items. Thus, if the uploaded media content is a Christmas carol, then the media content owner may want to specify that such media content is eligible to be paired with branded content having some form of a relationship with Christmas. Moreover, the branding criteria can also or alternatively take the form of branding prohibitions. The branding prohibition could be applied by the server a specific instruction to avoid pairing the media content item with certain types of branded content (e.g., brands that promote alcohol or cigarettes, or branded content meant to be consumed by audiences above a certain age). Further still, it should be understood that the branding criteria can include an enable/disable flag that permits or prohibits any branding from being applied to media content items.

In an exemplary embodiment, the media content source interface can also be configured to receive branding revenue sharing criteria. The branding revenue sharing criteria can define how much of any revenue derived from the pairing of branded content with the media content will be shared with the media content owner. The system can be configured such that the brand owners will be required to pay for exposure of branded content via pairing with the media content. Such branding revenue can then be split between an operator of the server platform and the owners of the media content. Through the brand revenue sharing criteria, media content owners can define for themselves what the split will be with the system operator. For example, the content owner 160 can set up revenue sharing criteria based on a certain ratio or percentage. As another example, media content owners can specify a fixed amount of revenue that must be reviewed per exposure or over a time period, a minimum amount for same, etc. In another embodiment, the system operator can define what the split will be with the content owner 160. Like the content owner 160, the system operator can set up revenue sharing criteria based on a certain ratio or percentage or specify a fixed amount of revenue that must be shared with the content owner 160. Furthermore, the media content source interface can also be configured to share a part or all of the revenue with non-profit organizations for a charitable purpose. The content owner 160 or the system operator can define what the split will be with a non-profit organization through the brand revenue sharing criteria. It should also be understood that the matching engine 116 that pairs media content items with branded content can take such revenue sharing criteria into consideration when choosing which branded content items should be paired with which media content items.

The server 110 stores the media information provided by the media content owners in the media database 122. FIG. 2A shows an exemplary structure of the media database 122. As shown in FIG. 2A, each entry of the media database 122 is comprised with a “Media Content Item ID” field, a unique identifier generated by the server 110 upon creation of the entry. Next to the “Media Content Item ID” field, a “Media Content” field, a “Metadata” field, a “Branding Revenue Sharing Criteria” field, and a “Branding Criteria” field are created. The “Media Content” field includes an actual file of the media content (e.g., a MP3 file for musical works). The “Metadata” field includes such information as artist, album, title, tags, genres, links, image (e.g., an album cover or artist's picture), lyrics, etc. The “Branding Criteria” field includes information such as the types of prohibited branding or preferred branding for the associated media content item. The “Branding Revenue Sharing Criteria” field includes information such as a fixed amount or ratio for sharing revenue.

A branded content source interface 172 can provide brand owners with an ability to upload branded content and related information to the brand database 124. This branded content source interface can be configured as a web platform accessed via the server 110. A graphical user interface (GUI) can be presented on computing device 170, where this GUI is configured to solicit from the brand owner the branded content itself (e.g., the actual media file that represents the branded content such as an image file to be used as an advertisement) and the metadata (e.g., descriptions) of the branded content. In turn, the server 110 can make an entry to the brand database 124 for newly uploaded branded content items to store the branded content and associated metadata in the database 124. A discussion of the types of metadata that can be solicited is included below in connection with the description of FIG. 2B. For example, the GUI can be configured to permit a media content owner to specify a product or service for the branded content, price information about the branded content, keywords associated with the branded content, etc.

Similar to the brand criteria defined by media content owners, the GUI accessed by computing device 170 can be configured to receive brand targeting criteria from brand owners. Such brand targeting criteria can set forth certain instructions or information for selection of media content that should be associated with the branded content.

For example, the brand owner can select a desired audience demographic parameter for use as a brand targeting criteria. By selecting a specific age-group or geographical region, the brand owner can target a specific audience for the uploaded branded content based on the audience's demographic information.

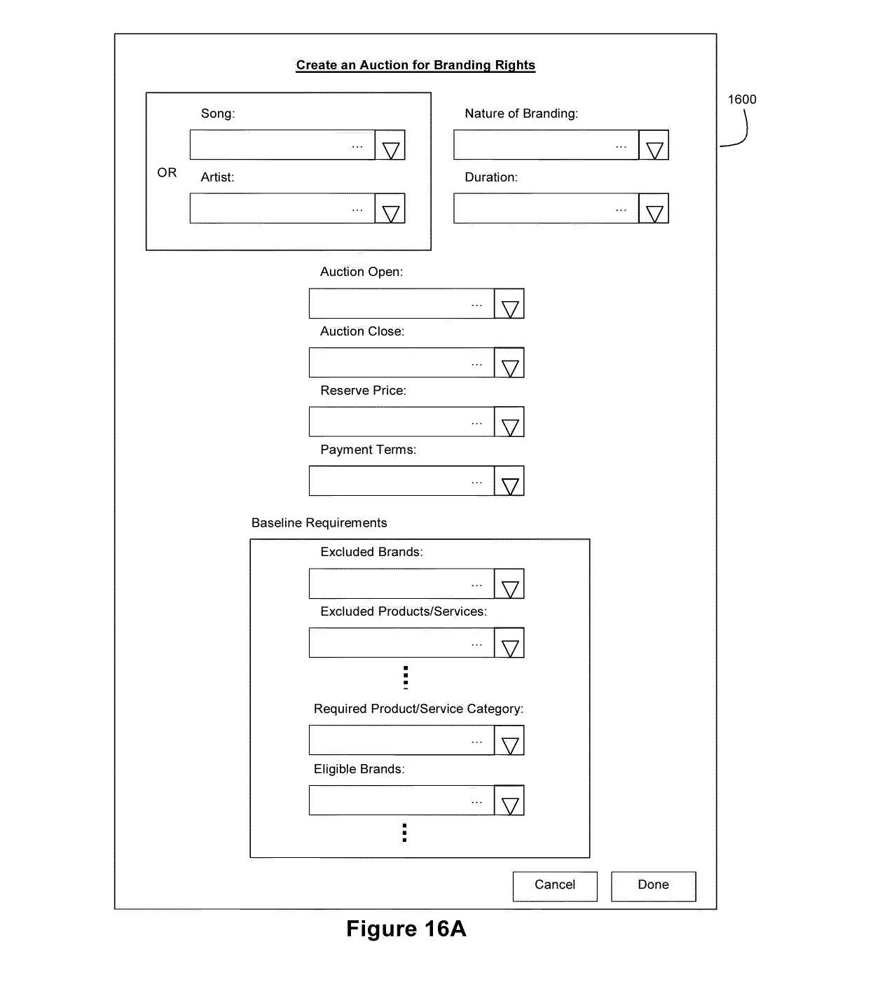

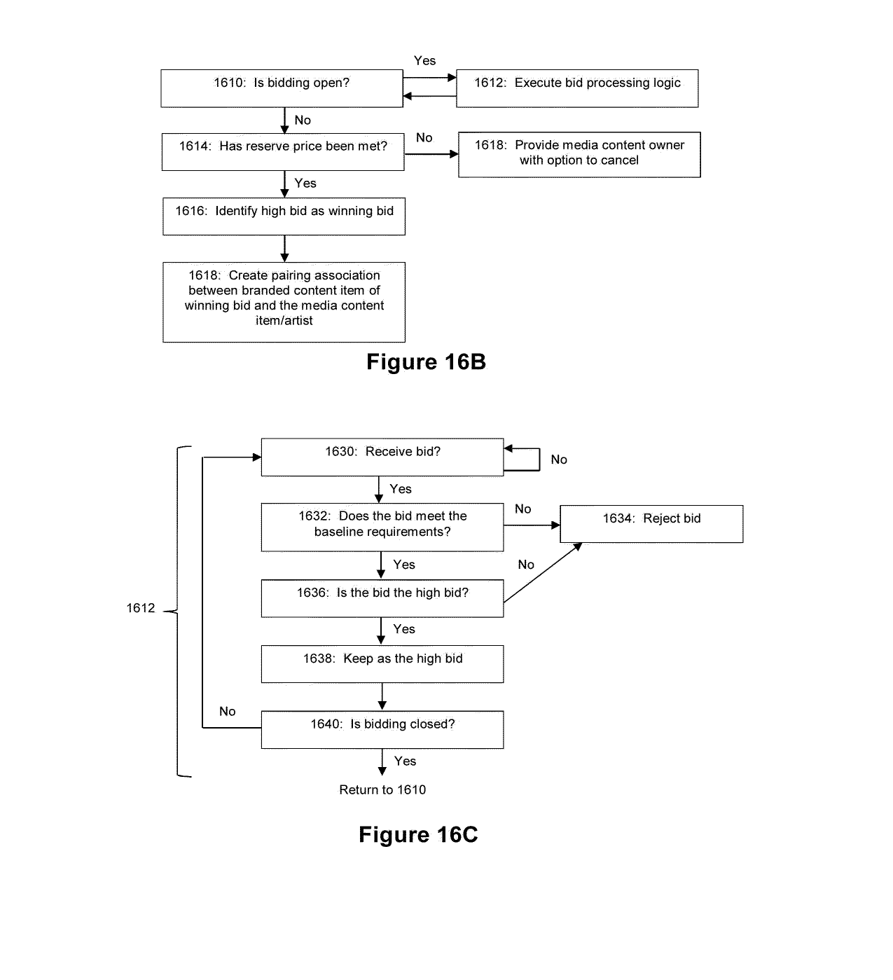

As another example, the brand owner can also be allowed to select a particular media content item or a media content artist for use as brand targeting criteria. For example, if a media content item is a musical work, the brand owner can target the fans of a particular song or musical artist by making such selection to therefore create an association that will allow the branded content to be delivered to the audience for that song or artist. Furthermore, as explained below, the system can be configured to permit brand owners to bid for the right to be associate their branded content with particular media content items, media content artists, and/or media content owners. The system can administer an auction of such exclusive rights so that media content owners can maximize the commercial value of the media content. An example of this is shown by FIGS. 16A-C.

FIG. 16A depicts an exemplary GUI 1600 for access by a media content owner via server 110 to create an auction for the branding rights with respect to a media content item (a song in this example) or a media content artist (a singer or band in this example). Through GUI 1600, a media content owner can define controlling parameters for the auction, in effect defining branding criteria for media content. For example, the owner can identify a song or artist whose branding rights are to be auctioned. Furthermore, the owner can specify the nature of the branding arrangement (e.g., an exclusive arrangement where only the branded content of the winning bidder will be associated with the selected song or selected artist; a non-exclusive arrangement where a defined number of brand owners will be permitted to pair their branded content with the selected song or selected artist; or other arrangements (e.g., exclusive/non-exclusive arrangements in particular product/service fields, etc.). The GUI 1600 can also be configured to permit the owner to define a duration for the branding arrangement (e.g., one month, six months, one year, etc.). Drop down menus or other input techniques can be used to collect the input parameters from the media content owner.

GUI 1600 also shows fields for the owner to define when the auction is to start and end. Optionally, the GUI 1600 can be configured to permit the owner to define a reserve price or the like that would provide the media content owner with an option to cancel an auction with no winning bid if a certain minimum price is not met. Further still, the GUI 1600 can be configured to permit the media content owner to define payment terms for governing the units of payment that bids are to be expressed in and by which the winning bidder is to pay the media content owner. For example, the payment terms can be a single lump sum monetary amount for the specified duration of the branding arrangement, a monthly lump sum monetary amount for the specified duration, a price per view monetary amount for the specified duration, etc.

Furthermore, if desired by a practitioner, through GUI 1600, a media content owner can define one or more baseline requirements for accepting bids. It is envisioned that some media content owners may not want certain songs or artists to be associated with certain brands, products, and/or services (e.g., a media content owner may not want an artist or a song popular with underage teenagers to be associated with tobacco or alcohol products, etc.). To provide the owner with control over how the media content is branded, controls such as those shown by FIG. 16A can be provided, including an ability to define one or more excluded brands, one or more excluded products/services, etc. Conversely, some media content owners might want media content to become specifically associated with certain products/service categories, classes of brands, etc. To provide this capability, the GUI 1600 can be configured to collect an identification of any of required product/service categories, eligible brands, etc.

FIGS. 16B and C depict exemplary processing logic that can be executed by server 110 to administer an auction of branding rights in accordance with an auction defined via GUI 1600. As shown by FIG. 16B, at step 1610 the processor checks whether bidding for an auction is open. If yes, the bid processing logic of step 1612 is executed to collect and process bids. Once bidding is closed, the processor ends execution of the bid processing logic and checks whether the defined reserve price has been met by the high bid (step 1614; if applicable). If the high bid satisfies the reserve price, then the high bid is identified as the winning bid (step 1616), and the server creates a pairing association between the branded content of the winning bid and the media content that was up for bid so that the paired branded content will be displayed when the subject media content is played. This pairing association can take the form of metadata in the database that will govern the selection of the branded content item of the winning bid when the media content item whose branded rights were auction is selected for playback by a consumer. If the high bid does not satisfy the defined reserve price, then the media content owner can be given the option to cancel the auction with no winning bidder (step 1618).

FIG. 16C elaborates on the bid processing logic of step 1612. At step 1630, the processor checks whether a bid has been received. The bid can include metadata that identifies the branded content to be paired with the media content up for auction, the brand content owner, the product/service category for the branded content, a price expressed in the specified units of the defined payment terms, etc. At step 1632, the processor checks whether the bid satisfies the defined baseline requirements for the auction. If not, the bid is rejected (step 1634). If the bid satisfies the auction's defined baseline requirements, then at step 1636, the processor compares the bid price with any previously received bid prices for acceptable bids to determine whether the received bid has the highest price. If the received bid has the highest price, then the received bid is kept as the high bid (step 1638). At step 1640, the processor checks whether bidding has closed for the auction. If not, the process flow returns to step 1630 to await receipt of another bid while bidding is still open. If bidding has closed, the process flow returns to step 1610 for progression to step 1614.

It should be understood that the auction can be administered as any of a number of auction types (e.g., open auctions where bidders can see the current high bid, closed auctions where bid prices are not visible to other bidders, etc.). If desired, the media content owner can also define an auction type via the GUI 1600. Furthermore, as should be understood, GUIs can be provided for access by the brand owners to prepare and submit bids to the system.

As still another example of brand targeting criteria, the brand owner can also select the size of an advertising campaign for the uploaded branded content. For example, the brand owner 170 can define the campaign size as an “X number of clicks”, “X number of views”, or “$X”. The server can be configured to limit the display of branded content items only within such limits specified by the brand owner, which would impact how the brand gets targeted to consumers.

Furthermore, the brand owner can also select a temporal duration for a branding campaign. For example, the brand owner can limit the duration of an advertising campaign of the branded content by configuring the brand targeting criteria such that the campaign runs for an X amount of time, X number of days, or from a certain day/time to a certain day/time.

Furthermore, it should be understood that the metadata keywords can also be used as brand targeting criteria. Further still, the brand owner can select which types of media content are eligible to be associated with the uploaded brand content items. For example, if an uploaded brand content item is an advertisement about Christmas trees, then the brand owner can include “Christmas” as a keyword or preference for the branded content item. Moreover, it should be understood that the brand targeting criteria may also include brand targeting prohibitions. For example, a brand owner may request that the system not pair a branded content item with certain types of media content items (e.g., some brand owners might prohibit certain brands from being associated with music having profane lyrics or that falls into certain genres).

The server 110 stores the brand information provided by the brand owners in the brand database 124. FIG. 2B shows an exemplary structure of the brand database 124. As shown in FIG. 2B, each entry of the brand database 124 is comprised with a “Brand Content Item ID” field, a unique identifier generated by the server 110 upon creation of the entry. Next to the “Brand Content Item ID,” a “Brand Content” field, a “Metadata” field, and a “Brand Targeting Criteria” field are created. The “Brand Content” field includes an actual file of the branded content (e.g., an image file for an advertisement). The “Metadata” field includes information such as a brand owner, product, price, keywords, description, etc. The “Brand Targeting Criteria” field includes such information as a desirable audience demographic parameter, defined campaign size, duration of campaign, and types of preferred media content. It should be understood that the above described exemplary structures of the media database 122 and brand database 124 are only intended to be an example and therefore should not be used to limit the scope of the present invention. Any other applicable database structure can be implemented to the exemplary embodiment of the present invention and additional information can be stored in the exemplary databases described above.

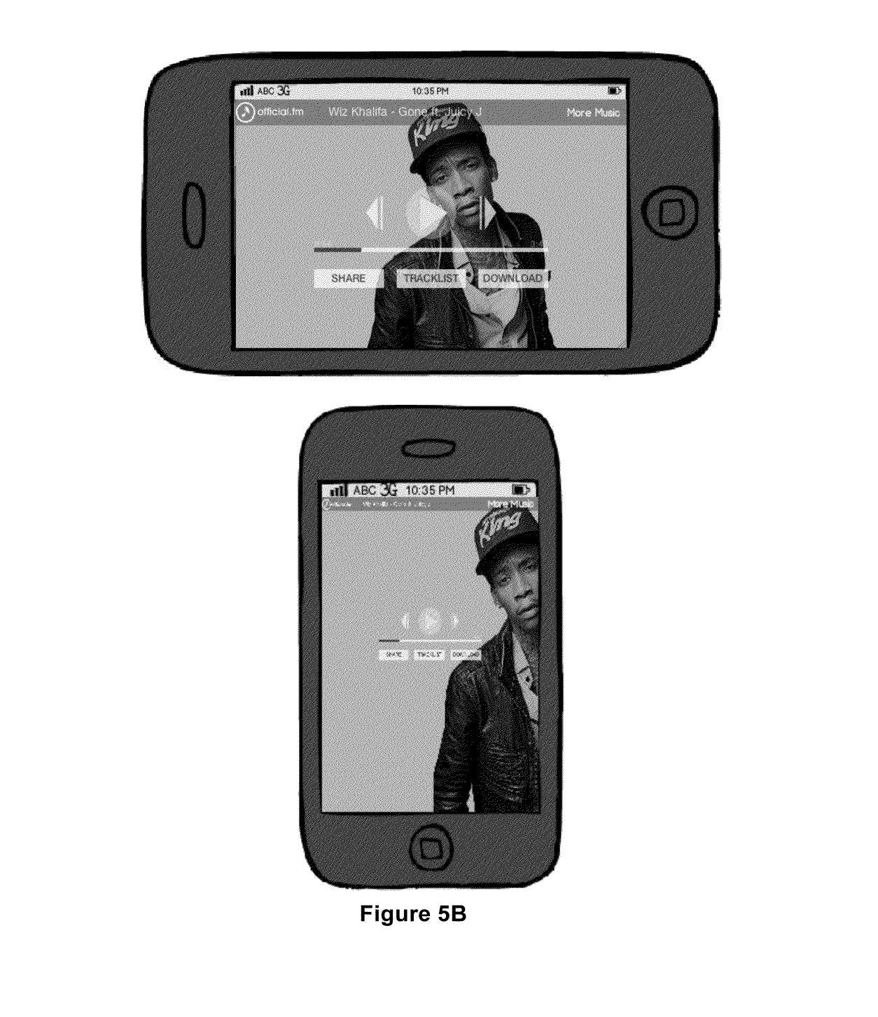

It is expected that a digital media player 152 will be the medium through which the media content and branded content are consumed. Such a digital media player 152 can take any of a number of forms. For example, a wide variety of digital media players are already in widespread use. Moreover, it should be understood that while the digital media player 152 will be accessed and played from a consumer's computing device 150, it need not be the case that the logic for the digital media player be fully resident on the consumer's computing device 150. For example, the digital media player can comprise logic resident on a server and accessed from a web page (see, for example, the web page shown in FIG. 5A). In such an embodiment, the server 110 acts as a web server hosting a web page which includes a digital media player 152. The web page can be formatted as a digital media player 152 such that the consumer 180 can play the media content by accessing the web page hosted by the server 110. In such an instance, the computing device 150 can be configured with conventional browser application 159 for purposes of interfacing with the server 110. In other embodiments, the browser 159 on the computing device can include plug-in or native logic that is configured to serve as the digital media player. Still further, the digital media player 152 can be an application that is executed by the computing device 150 (such as a mobile application or the like downloaded from the server 110 or a third party provider (e.g., download from an “app” store or the like). In another embodiment, a digital media player 152 can take the form of a digital advertising panel such as newsstand kiosks, information panels, touchscreens, or showscreens which can be installed on bus shelters or the like. In this embodiment, a digital advertising panel can be used to render the media content and branded content. Furthermore, the user can connect to a digital advertising panel in the street through a mobile device such as a smartphone to download the media content and branded content for play. Thus, in various embodiments, the digital media player 152 can comprise a plurality of computer-executable instructions resident on a non-transitory computer-readable storage medium such as a computer memory. Moreover, in some embodiments, the digital media player can be configured to be exportable and embeddable into other viewing environments to permit flexible sharing by consumers.

In an exemplary embodiment, the digital media player 152 can include logic that periodically sends a request to the server 110 for a branded content item to be paired with the media content item it plays. Upon receipt of a branded content item from the server 110 in response to the request, the digital media player can be configured to cause the visual display capability of the computing device 150 to display the branded content item. For example, the digital media player can be configured to cause the visual display capability of the computing device to alternate between a visual display of the branded content item and a visual display of a metadata image for the played media content item. This alternating sequence can be defined on a time basis (e.g., switching between the display of the branded content item and the metadata image every X seconds) or an a triggered basis (such as switching in response to a user input, etc.).

It should be understood however that the logic for requesting branded content from the server 110 need not be hard coded in the digital media player itself. If desired, a practitioner may choose to include such code logic in digital media data structures themselves that include data representative of the media content item. Then, as the digital media player accesses the digital media data structure to play the media content, it can execute the request logic upon encountering it in the data structure.

Pairing Media Content with Branded Content

In the exemplary embodiment, the server 110, using the matching engine 116, initiates a pairing process when the user 180 makes a selection of media content. The matching engine 116 can be a software program or hardware or a combination of both that can be executed by the server 110 to administer the pairing process. In an exemplary embodiment, the matching engine is invoked when the server receives a call from a digital media player that a particular media content item has been selected for playback.

The matching engine 116 can be configured to search through the brand database 124 for branded content that is deemed a match with respect to the selected media content. To facilitate this matching process, the matching engine can process metadata for the selected media content to make assessments as to which branded content items should be deemed matches with respect to a selected media content item. This matching process can also leverage other information such as metadata for the branded content items, branding criteria for the media content items, brand targeting criteria for the branded content items, and/or information about the consuming user (e.g., demographics, location, etc.). Furthermore, it should be understood that the metadata about the selected media content need not be limited to the pre-stored metadata shown in FIG. 2A, but could also include derived features about the selected media content that are generated dynamically as the selected media content item is played by a digital media player. This matching process can employ any of a number of metrics for assessing whether a particular branded content item present in the brand database 124 should be deemed a match to the selected media content item based on the types of information discussed above.

Examples of media content metadata that can be processed by the matching engine include, but are not limited to, lyrics, artists, albums, titles, genres, subgenres, moods, themes, tags, keywords, tempo, rhythm (e.g., musical meter, rhythmical pattern, etc.), harmony (e.g., minor, major, modal, atonal, blues, etc.), melody (octave range, trajectory, etc.), colour analysis of the artwork or pictures associated with the media, pattern recognition on the artwork or pictures associated with the media (e.g., a car on the picture or a mountain). Examples of branded content metadata that can be processed by the matching engine include, but are not limited to, product name, price, and keywords. It is envisioned that brand owners will select keywords for branded content in a manner that leverages the known characteristics of the matching engine to describe aspects of the branded content that are useful for pairing with media content or aspects of media content with which the brand owner wants to be associated. As mentioned, any of a number of keyword matching algorithms can be used for such matching purposes.

Conceptually, the matching algorithm can leverage the brand criteria of the selected media content item and the brand targeting criteria for the branded content items in the brand database to identify a set of branded content items that are eligible for pairing with the selected media content item. This set eligible branded content items can then be further reduced through filtering based on metadata matching or other constraints (such as user information as discussed below, brand revenue sharing criteria, etc.).

Also, it should be understood that the matching engine can be repeatedly invoked while the selected media content item is played through a digital media player. As such, different branded content items can be selected and presented to a consumer through the digital media player as the media content item is played. For example, continuing with the song example, at the 30 second mark in a song, the digital media player can switch from an image of the artist for the song to an image for branded content item A. At the 60 second mark, the digital media player can return to the artist image, and then at the 90 second mark, the digital media player can switch to a display of an image for branded content item B after the matching engine. Similarly, the matching engine can execute once to generate a ranked list of branded content items, where this list is traversed to select which branded content items are to be displayed as the media content plays.

It should further be understood that the matching engine can optionally be configured to leverage the media content itself to find relevant branded content. For example, in an embodiment where the media content item is a song, a signal processing application can process the playback signal for the media content to determine the words of the song lyrics, and the matching process can be run against the detected words to find branded content items relevant to those words. However, if such a feature is desired, it should be understood that the song lyrics need not be detected in from the playback signal if another source of lyrics is accessible (such as within the stored metadata or a third party database of song lyrics). In such an instance, the matching engine can access the lyrics through the metadata or the database to identify the lyric words to run the matching operation against.

Pairing Media Content with Branded Content Based on the User's Location

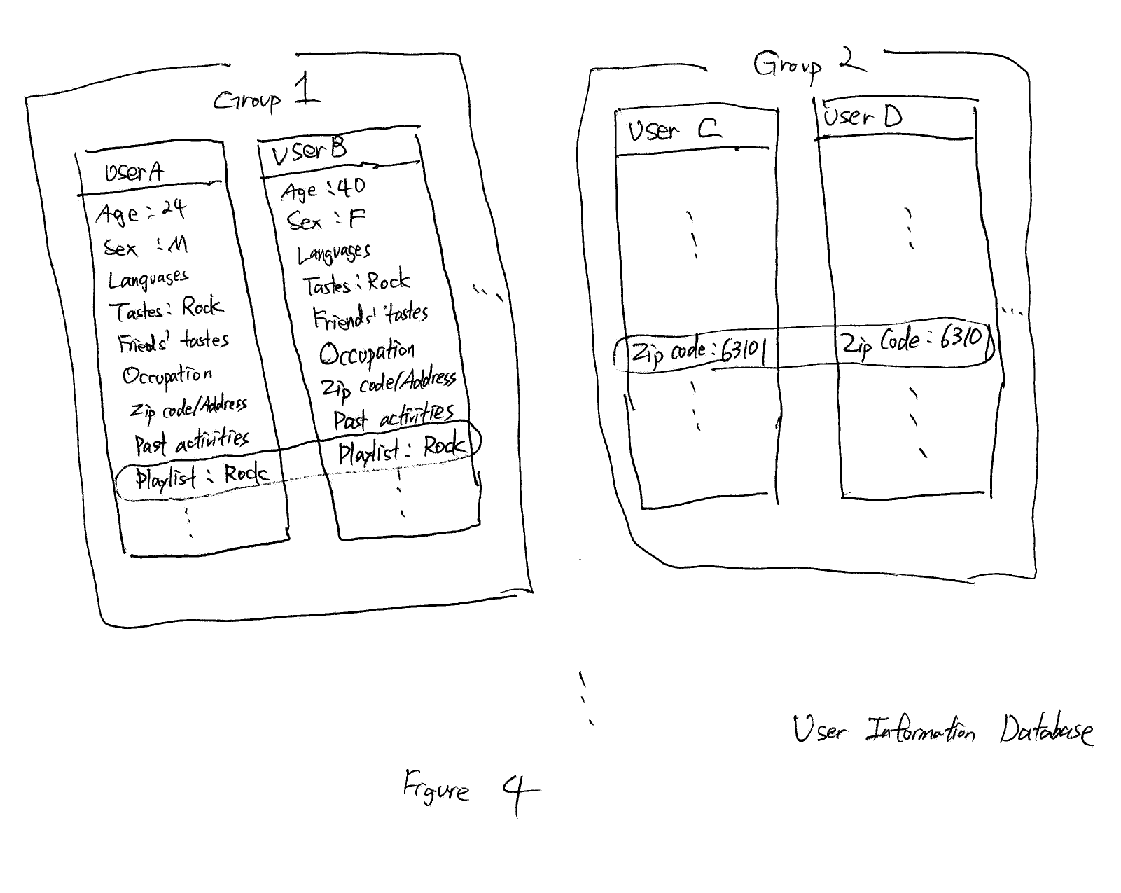

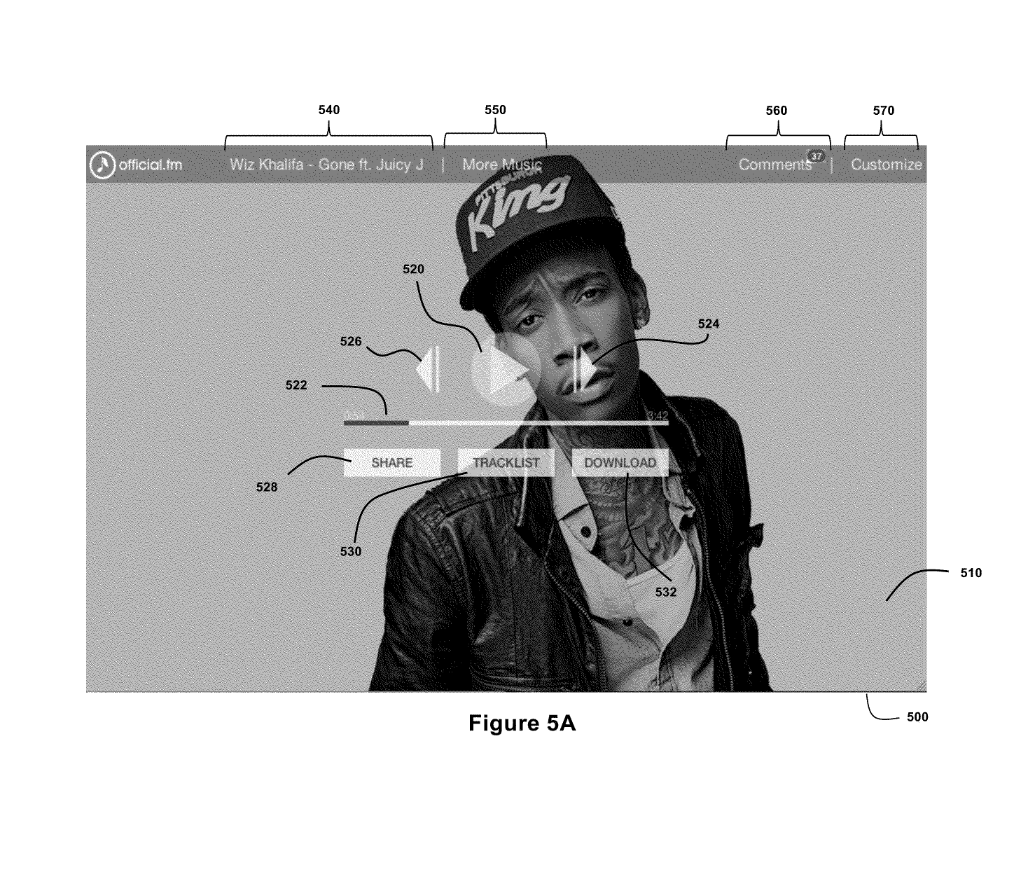

In an exemplary embodiment, branded content items can be selected by the server 110 based on the geographical information of the user 180. In this embodiment, the computing device 150 is featured with the GPS component 155 of FIG. 1. The GPS component 155 of the computing device 150 tracks the location of the user 180 and sends the location information to the server 110. The server 110 then searches the geo-localisation database 150 to find any information that corresponds to the coordinates provided by the GPS component 155 of the computing device 150. FIG. 3A shows an exemplary structure of the geo-localisation database 150. As shown in FIG. 3A, the geo-localisation database 150 may contain known and available GPS coordinates of areas and location information corresponding to each coordinate. For example, if a user 180 is travelling through St. Louis, Mo., the computing device 150 (which may be a mobile device in this instance) sends the GPS coordinates within the St. Louis area to the server 110. The server 110 then uses those coordinates to find the corresponding location information (e.g., “St. Louis Downtown”) in the geo-localisation database 125. Next, the server 110 uses that location information to find any branded content in the brand database 140 that describes downtown St. Louis, e.g., an advertisement related to the St. Louis Cardinals baseball team. The matching engine 116 then pairs the selected branded content item with the media content item. Additionally, the matching engine 116 can be configured to make such pairing also dependent on other criteria such as discussed above. Thus, such embodiments can permit brand owners to target particular consumers who are located in particular areas.

Similarly, the user's IP address can be utilized to identify branded content that relates to the location information of the user. In this embodiment, the computing device 150 sends its IP address to the server 110, which in turn, uses the matching engine 116 to search the IP-geolocation database 160 for purpose of finding location information that corresponds to the given IP address. FIG. 3B shows an exemplary structure of the IP-geolocation database 160. As shown in FIG. 3B, if a given IP address corresponds to a zip code “63101,” then the matching engine 116 will fetch “St. Louis Downtown” from the location information field and use “St. Louis Downtown” to find branded content whose metadata includes information related to downtown St. Louis.

In another embodiment, current local time can be utilized to control the selection of which branded content is selected for display. In such an embodiment, the computing device 150 or any component thereof can be configured to track a local time as the user moves around. The tracked time information is transmitted to the matching engine 116 which in turn uses the time information to find branded content that best suits the current local time. For example, branded content for products/services more likely to purchased at night can be associated with evening hours to target consumers during those time while branded content for products/services more likely to be purchased during the day can be associated with daytime hours. Thus, the matching engine can be configured to switch to the branded content that best suits the user's location information and current local time for a specified time or time time period.

It should be understood that the above described exemplary structures of the geo-localization database 150 and the IP-geolocation database 160 are only intended to be an example and therefore other embodiments can be implemented as other applicable database structures can be used to accomplish location-based pairing.

Pairing Media Content with Branded Content Based on the User's Profile

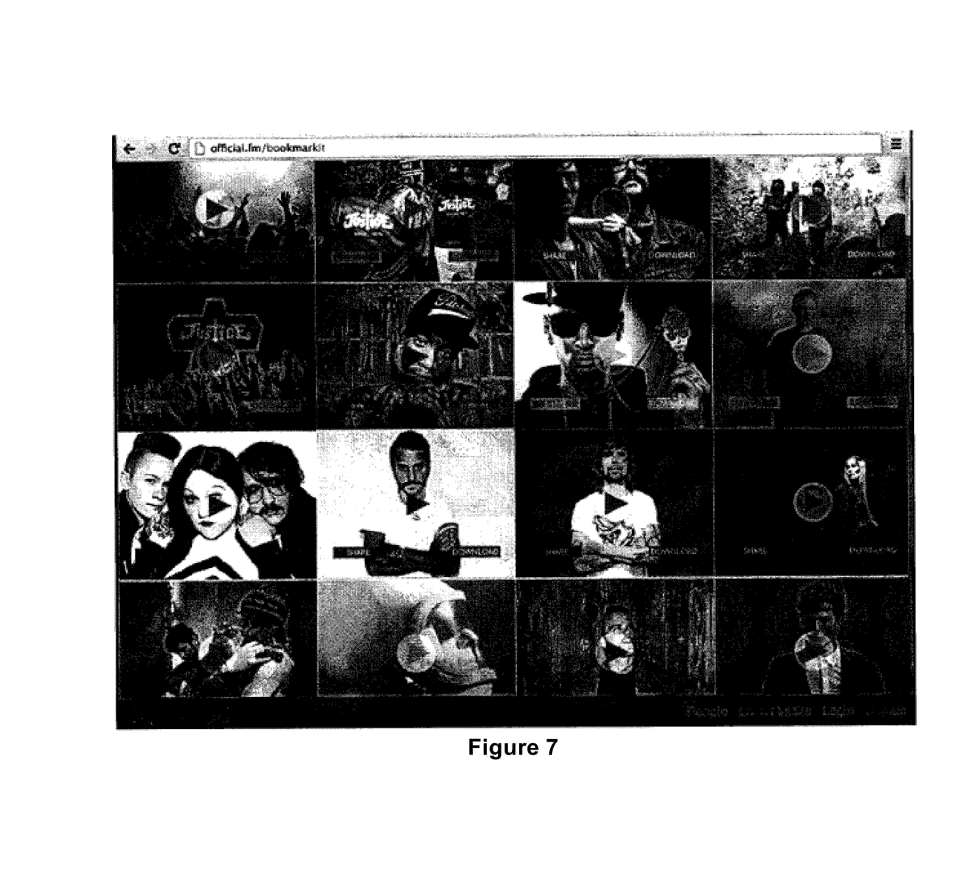

In another exemplary embodiment, branded content items can also be selected based on a user's profile information. In other words, branded content can be selectively chosen depending on certain information specific to a user such as age, gender, language, tastes, friends' tastes, occupation, zip code or address, past activities (e.g., the user's past searches), the user's playlist, or any information that is specific to a user. FIG. 4 shows an exemplary structure of the user information database 120. For example, if a user is a teacher, the system can pair branded content items that are related to educational materials to the user's media content items. If a user's profile indicates an interest in baseball, the system can pair branded content items that are related to sporting goods or services to the user's media content items. If a user frequently listens to rock music or the user's playlist (as shown in FIG. 7) is comprised with many rock music songs, then the system could pair branded content items that relate to rock music to the user's media content items. Additionally, as discussed, the matching engine 116 can be configured to make such pairing also dependent on other criteria such.

Various types of information about the user can be stored in the user information database 120 which is accessible by the server 110 and it should be understood that any of a number of database structures can be used to implement the user information database 120.

Additionally, the server 110 can be configured to identify any common interest (if any) among multiple users. The server 110 can automatically present ideal branded contents that may be of a common interest to multiple users by pairing those branded contents with the users' media contents.

Also, in an exemplary embodiment, the matching engine 116 is configured to provide a dynamic pairing between the user's media content and one or more of branded content items stored in the brand database 124 in real-time. With such an embodiment, the matching engine 116 is configured to initiate the pairing process after a user 180 has selected a certain media content item that he or she wants to play. After the user 180 has made a selection, the matching engine 116 starts the process of searching the media database 122 and the brand database 124 to find a match between the selected media content item and at least one branded content item as discussed above. By waiting until media content selection by the user, the system can ensure that the most up-to-date information available is taken into consideration when selecting the branded content to be presented to a consumer. Thus, the branded content associated with the selected media content can be updated even during the play of the media content. Examples where such dynamism can be useful are where the user's location is changing (in embodiments where brand targeting leverages the detected user location), or where different brand owners are frequently updating their advertising campaigns.

### Communications Between the Server and the Computing Device

The server 110 and the computing device 150 can be configured to interact with each other in a number of different ways. For example, in an exemplary embodiment, the matching engine 116 can be executed by the server 110. However, this need not be the case as all or a portion of the matching engine logic can optionally be executed locally by the computing device 150. In such a case, the matching engine executed by the computing device can be configured to access the media and brand databases as needed, or all or portions of the media and brand databases can be copied to the computing device for local storage on the computing device. For example, in a scenario where a consumer already has a large library of media content on his or her computing device, a practitioner may choose to periodically push a brand database onto the computing device for local execution of the overall process.

Also, as mentioned, the digital media player 152 can be executed locally by the computing device 150, but if desired all or a portion of the digital media player logic can optionally be executed by the server.

Furthermore, in some exemplary embodiments, the media content files themselves may be stored only on the server and then streamed through the computing device for playback. In such embodiments, only metadata for the media content may be stored locally by the computing device (e.g., where the media content is a song, the computing device 150 may locally store only information such as song title, artist, etc. However, in other embodiments, the media content files may be stored locally by the computing device 150 for playback through a digital media player.

Given these various options, the communications between the server 110 and computing device 150 can be designed to appropriately meet the needs of a given implementation.

Display of Branded Content with Media Content Playback

FIG. 5A illustrates a background image for a selected media content item as rendered by a digital media player through a web browser. In this example, the media content is a song, and the digital media player is a digital music player. The display 500 shows the background image 510 through the display screen 153 of the computing device 150. Alternatively, the same or similar display can be rendered on a mobile device as shown in FIG. 5B. Preferably, any picture or image related to the media content, such as a picture of an artist or an album cover, can be displayed. As discussed, such an image can be included as metadata for the media content item. In addition, the background 510 can be rendered in a form of a slideshow comprising multiple pictures of an artist or in a form of a video clip comprising a music video. The display 500 also shows user input controls, for example a “Play” button 520, a “Progress Bar” 522, a “Next Track” button 524, a “Previous Track” button 526, a “Share” button 528, a “Tracklist” button 530, a “Download” button 532, a “Song Title” field 540, a “More Music” link 550, an “Comments” link 560, and a “Customize” link 570. The display 500 can be shown in a full screen mode of the computing device 150 but it should be understood that any screen mode can be used for the display 500 as well.

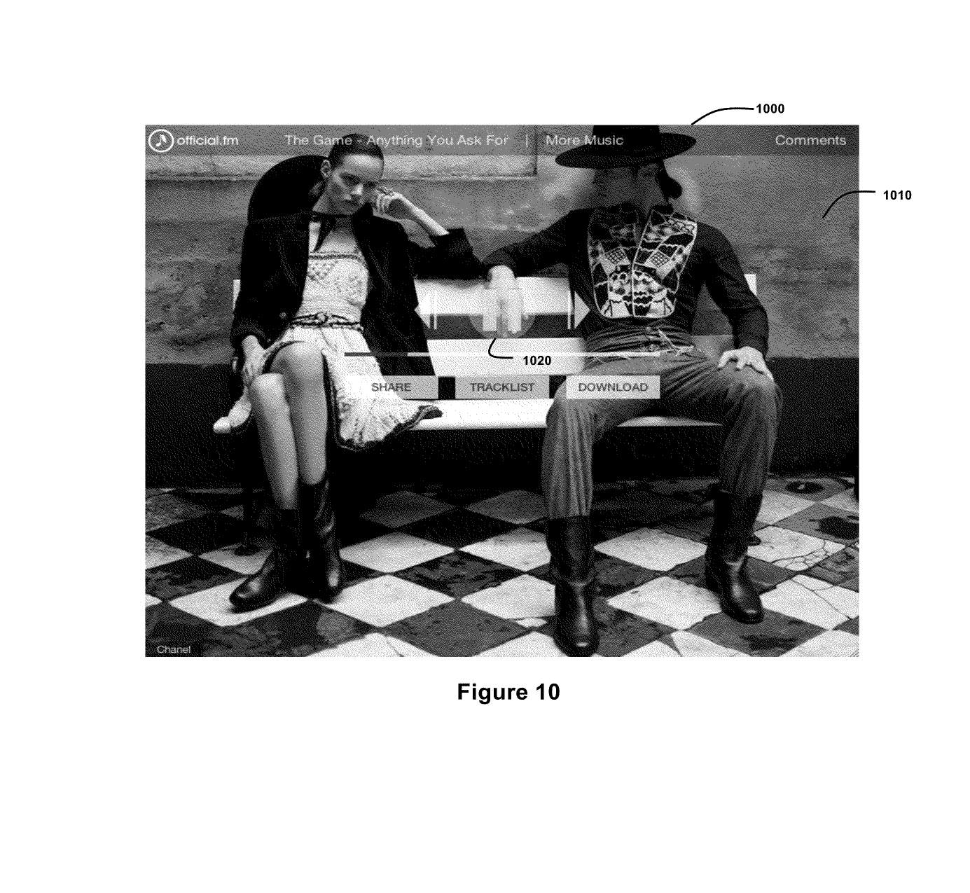

When the user clicks the “Play” button 520, the computing device 150 starts to play the selected media content item. As the media content item plays, the player can be configured to cause the display to transition from the background image 510 to a branded background 1010 as shown in FIG. 10, which displays the branded content item that was paired with the selected media content item. As discussed below, this transition can be performed in any of a number of manners.

Also, the digital media player 152 can be configured to cause the display screen 153 to switch between the media background image 510 and the branded background image 1010 in an alternating manner. In an exemplary embodiment where the media content is music and the branded content is an image, the user is able to consume the branded content without disturbing the user's consumption of the music. Moreover, the digital media player 152 can alternate between the media content background and the branded content background in a number of ways. For example, the alternation can be on a timed basis (e.g., switching between the media content background and branded content background every X seconds). As another example, the alternation can be on a user-triggered basis (e.g., switching based on a cursor move over the screen, switching when the user provides an input such as a screen tap (for an embodiment where the user computing device has a touchscreen user interface), or a re-orientation/tilting of the user computing device, etc.). As still another example, the alternation can be performed based on a characteristic of the media content itself. For example, in an embodiment where the media content is music, the tempo or rhythm of the music can be analyzed to cause the alternation to occur at specific peaks or intervals of the music. Similarly, the alternation could be timed to coincide with the timing of certain lyrics in the music (e.g., when the music in question is a Christmas song with lyrics that mention a Christmas tree, timing the display of branded content for a Christmas tree that coincides with the mention of a Christmas tree in the lyrics). As still another example, the alternation can be triggered by a determined location for the digital media player. It is envisioned, particularly in cases where the user computing device is a device such as a smartphone, portable mp3 player, or the like that is configured to track a user's geographic location, that the user will be on the move while consuming media content. In such a case, the display of branded content can be triggered by the determined location for the digital media player (and thus the user). Thus, if a user is near a store that wants to target fans of a particular musical artist, the digital media player can present branded content for the store if the user is detected to be located near the store while listening to particular music.

Any of a number of transition effects can be employed while the display switches from a media content background to a branded content background. For example, a flipping transition could be used to provide an appearance that the media content background is flipping over to reveal the branded content background (and vice versa). Such flipping can be accomplished in a number of different ways. For example, the flipping transition can be a three-dimensional (3D) animation that flips the display around a vertical axis (or a horizontal axis or any other axis) revealing a media player with an alternate background. Furthermore, the transition effect can be a cross fading from one background to another, a sliding from one background to another, a mosaicking from one background to another, etc.

The user 180 is provided with a variety of audio playback features such as the “Next Track” button 524 and the “Previous Track” button 526 as shown in FIG. 5A; however, it should be understood that other conventional audio playback features not shown in FIG. 5A can also be implemented. The “Progress Bar” 522 indicates the duration of the song and the current playback position, and further provides the user 180 an ability to navigate to another position in one click.

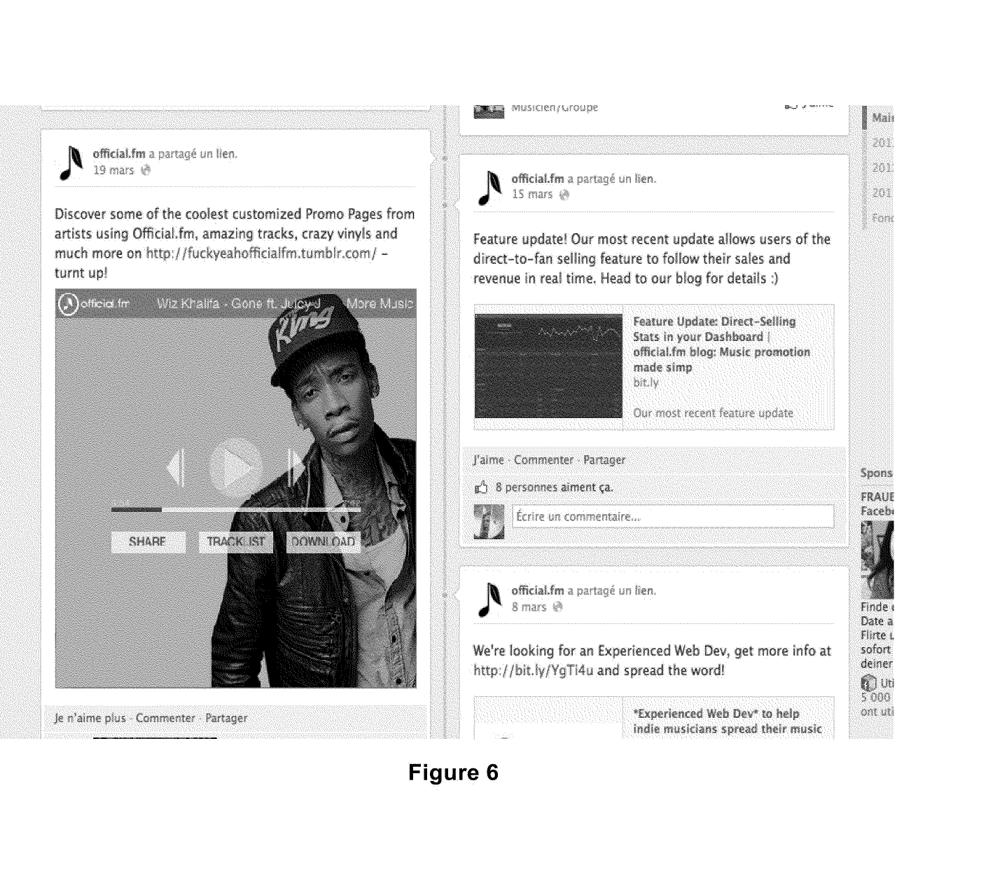

If the user 180 clicks the “Share” button 528 of FIG. 5A, the user 180 is allowed to share the brandable media with another person. FIG. 6 illustrates an exemplary display of a social networking website embedding brandable media according to an embodiment of the invention. For example, once the user 180 clicks the “Share” button 528, a new screen populates where the user 180 is allowed to embed the brandable media a social networking site such as facebook.com, Linkedin, Twitter, Google Plus+, Tumblr, etc. The user 180 can post the brandable media and write a comment about it. Any person who is connected with the user 180 through one of the social networking sites, can click the “Play” button 520 and play the posted brandable media format. If one of the triggering events for flipping a media background has occurred, a media background will be flipped over to a brand background, so that the branded content paired with the posted media content can be seen by other people as well (as explained above in FIG. 5A)

If the user 180 clicks the “Tracklist” button 530, the song currently being played can be added to the user's playlist and a new screen populates which shows a list of songs that were already added to the user's playlist, if any. FIG. 7 shows an exemplary display screen of a computing device, showing a user interface for a user's playlist. As shown in FIG. 7, each song in the user's playlist can be rendered in a media player form just like that of FIG. 5A. In this example, the user 180 can select a song from his or her playlist by selecting one of the songs listed therein.

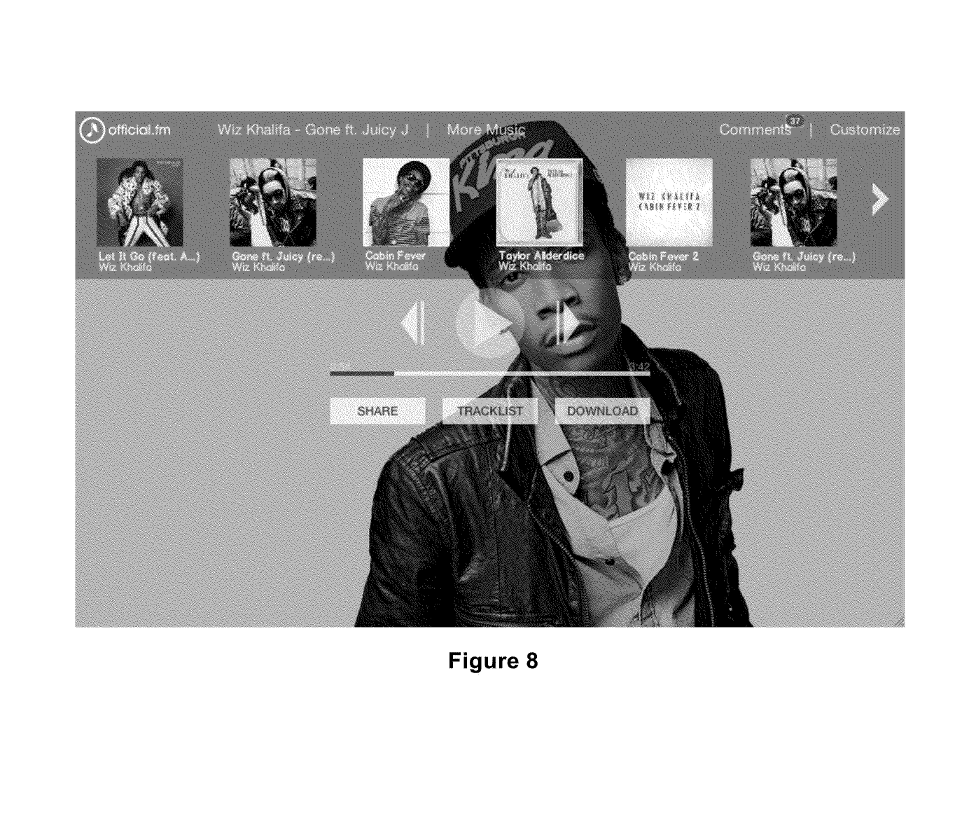

The “Song Title” field 540 displays a title of the song that is being played. The “More Music” link 550 provides a link to a new page where the user 180 is allowed to choose more media content items, e.g., songs. Preferably, upon clicking the “More Music” link 550, a new screen populates, which shows a list of songs that are available to the user 180 (as shown in FIG. 8). When the user 180 clicks one of the songs listed therein, the display 500 of FIG. 5A changes accordingly, showing a picture or image that is related to the song newly selected by the user as a new background image.

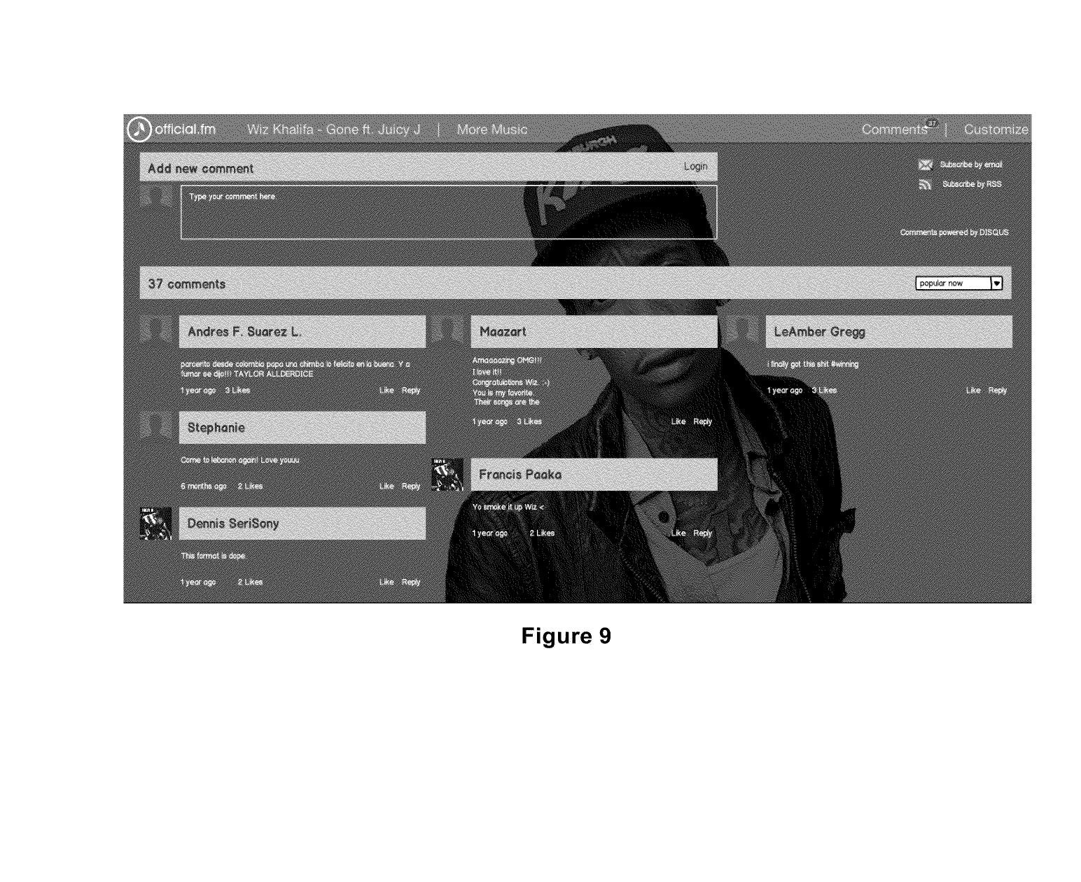

If the user 180 clicks “Comment” link 560, a new screen populates in which many fillable data fields are shown. As shown in FIG. 9, the user 180 can write comments about media content or branded content in one of the data fields and can also read other people's comments.

The “Customize” link 570 allows the content owner 160 to customize media content items uploaded by the content owner 160 and the branded owner 170 to customize branded contents uploaded by the brand owner 170. As explained above in FIGS. 2A and 2B, the content owner 160 can enable or disable branding of the media contents, customize the background 510 of the media content with a personalized picture or image, describe the content of the media (e.g., specify genre or add tags), or select the branding criteria for branded contents that should be associated with the media content. Likewise, the brand owner 170 can select the brand targeting criteria through the “Customize” link 570. For example, as explained in FIG. 2B, the brand owner 170 can select a desired audience demographic parameter, particular track or artist, bidding option for an exclusive branding, size of an advertising campaign, duration of the campaign, or types of media content that should be associated with the brand content. Furthermore, the brand owner 170 can write a description of the branded content. If the user 180 clicks the “Download” button 532, the computing device 150 downloads the brandable media format that is being selected or played by the user 180 from the server 110.

FIG. 10 illustrates a display of a branded content item rendered through a media player on a desktop computer. The display 1000 of FIG. 10 is effectively the same as display 500 of FIG. 5A but for the different background image. It should be understood that the digital media player can be configured to redirect the user 180 to a website associated with the branded content item if the user 180 clicks on (or touches in a touchscreen interface embodiment) any part of the branded background. In addition, the digital media player can be configured to display additional information about branded content if the user moves a mouse cursor to a specific region of the displayed branded content image. For example, if a user hovers a cursor over or otherwise selects (e.g., touches via a touchscreen) a particular region of the image, a description of a product or service for the branded content can be presented to the user. Continuing with such an example, if the branded content image comprises a picture of a model wearing shoes (and where the brand in question is a shoe brand), the digital media player can be configured to display a description of the shoes if the user places a cursor over the shoes (or touches the shoes through a touchscreen display). This description can also be selectable to redirect the user to a website associated with the shoes where the user can directly purchase the shoes online.

Also in an exemplary embodiment, when the user 180 selects the “Pause” button 1020, the computing device 150 stops playing media content and enters into a paused state. At the same time, the digital media player can cause the brand background 1010 to flip over and return to the media background 510 of FIG. 5A. If the user clicks the “Play” button 520 of FIG. 5A again, the display 500 can once again transition back to the branded background 1010 and the computing device 150 resumes playing the media content

While in this example, the branded content item is an image, it should also be understood that the branded content can be a movie or video clip. For example, the branded content can be rendered as a movie file or video file comprising advertising materials like TV commercials. In such an embodiment where the media content is a song, to minimize the disruption to the user, the branded video can be displayed during periods where the user has paused the song.

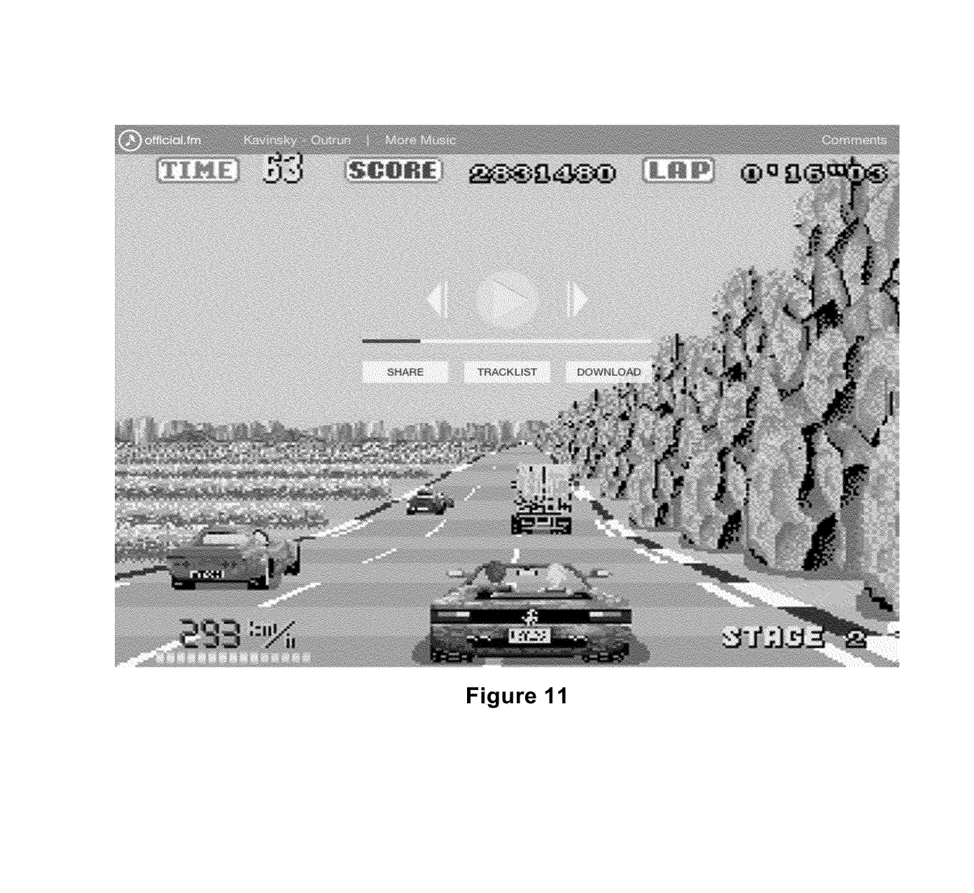

As another example, the branded content can be presented to the user 180 in a form of a game. FIG. 11 shows a branded background rendered as a vintage car video game. It should be noted that such a video game display can be configured for play by the user while the user listens to the selected music.

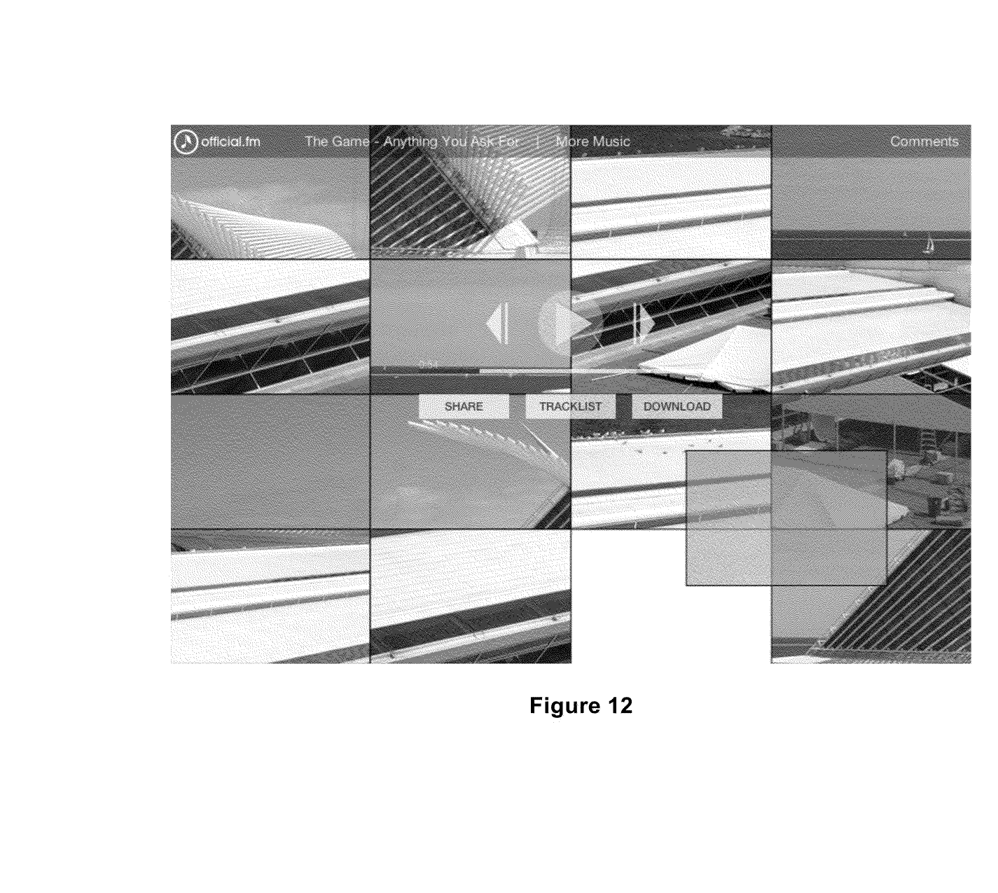

Furthermore, a branded content image can be configured to provide user interactivity. For example, FIG. 12 shows a branded background of a brandable media format rendered as a puzzle game. The branded content image can be divided into portions that are presented in a puzzled format (i.e., a jumbled format where a clear display of the image would require a re-arrangement of the image portions). The digital media player can be configured to permit the user to select image portions and move the selected image portions around the display screen to re-arrange the branded content image in an attempt to reveal the branded content image in an unpuzzled format. It is expected that such a feature will provide the user with an entertaining diversion while listening to a song, and also cause the user to focus more closely on the branded content image itself.

In the embodiment in which the media content comprises a video work, any picture or image related to the video work (e.g., a screenshot of a video game) can be displayed as the background image 510 of FIG. 5 and different user input controls appropriate for video control can be displayed such as fast-forward, rewind, play, pause, etc. instead of audio playback controls. In this embodiment, the branded content paired with the media content can be configured to comprise audio branded content. As the user clicks the “Play” button 520 of FIG. 5, the computing device 150 starts to play the media content item (i.e., video work). As the media content item plays, the player can be configured to cause the display to transition from the background image 510 of FIG. 5 to the background 1010 of FIG. 10, which will display the media content (i.e., video work). At the same time, the player can also be configured to cause to play the branded content (i.e., audio branded content) paired with the media content so that the user can consume both the media content and the branded content without interruption.

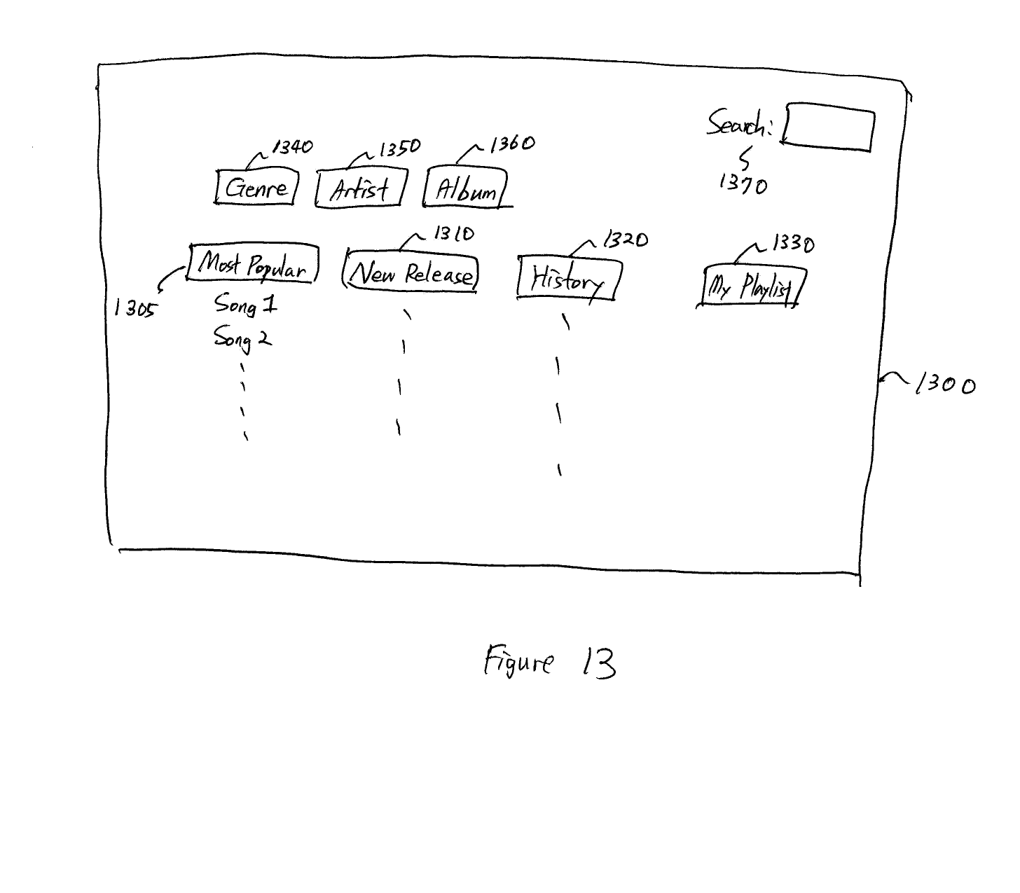

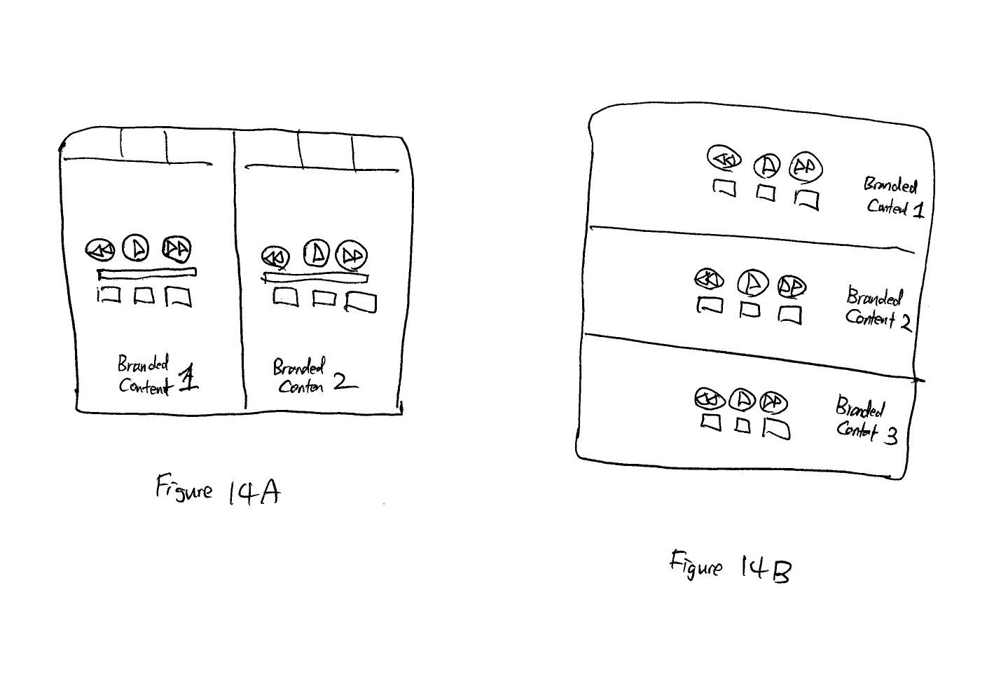

FIG. 13 illustrates an exemplary display screen of a computing device, showing a media content consumer user interface 1300. This interface 1300, which can be accessible via a digital media player, via server 110 or otherwise, can be configured to permit users to search for and navigate to media content of interest. In the example of FIG. 13, the interface 1300 may include a “Most Popular” field 1305, a “New Release” field 1310, a “History” field 1320, a “My Playlist” link 1330, a “Genre” link 1340, an “Artist” 1350 link, an “Album” 1360 link, and a “Search” field 1370. In an exemplary embodiment, the interface 1300 can be presented on a display screen of the computing device 150 when the user 180 clicks the “More Music” field of FIG. 5A, but it should be understood that the interface could also be accessed in other ways. For example, the interface 1300 could be a home page or other page of a mobile or other application executed by a computing device 150. Similarly, the interface 1300 can be a home page or other page of a website hosted by server 110.

The “Most Popular” field 1305 lists media contents (e.g., songs) that are ranked as most popular by some metric, for example, in the Billboard charts either in a weekly, monthly, or yearly basis. The “New Release” field 1310 lists songs that are recently released. The “History” field 1320 lists songs that were selected or played by the user 1380 in the past. When the user 180 selects one of the songs in one of these three fields, the display 1300 turns into the display 500 of FIG. 5A, where the user 180 is allowed to click the “Play” button 520 of FIG. 5A in order to play the selected media content. The “My Playlist” link 1330 provides virtually the same function as the “Tracklist” button 530 of FIG. 5A. The user 180 can freely add, delete, or modify songs in his or her playlist through “My Playlist” link 1330.

The user 180 can also search for more media by typing in a search keyword into the “Search” field 1370. If the user 180 uses, for example, “Rock” as a search keyword, the server can be instructed to perform a search in the media database for media content related to “Rock”. For example, the server 110 can search the media database for all media content having metadata that matches the word “rock” in fields such as title, artist, keywords, etc. The results from such a search would then be presented to the user through a media content consumer user interface. The user 180 can select one of the listed media content items by clicking on it or the like. Upon user selection of a media content item, the server 110 can then search the brand database for branded content item(s) to be paired with the selected media content as discussed above.

The user 180 can also search more media content by fields such as genre, artist, or album. As shown in FIG. 13, the “Genre” field 1340 allows the user 180 to choose a particular genre of music. The “Artist” field 1350 allows the user 180 to search songs of a particular artist. The “Album” field 1360 allows the user 180 to search songs by an album name.

In another embodiment, the search function can be expanded to branded contents. For example, the user 180 can search for branded content by typing in one or more search keywords in a search field similar to “Search” field 1370. This capability can be provided through a modified version of interface 1300 or a separate user interface for searching branded content. In turn, the server 110 can search the brand database for relevant branded content in the same fashion as described for searching the media database. A user interface can then present the branded content search results to the user. Moreover, upon selection of a branded content item for display, the matching process can be similarly run to pair one or more media content items with the selected branded content item. If only one media content item is paired with a selected branded content item, a digital media player can be configured to display the selected branded content item and the paired media content item in an alternating fashion as previously discussed. If multiple media content items are paired with a selected branded content item, a user interface can solicit a selection from the user of one of the paired media content items for playback in conjunction with the selected branded content item. Thus, by extending search functions to branded content, users can not only discover brands through media content but can also discover media content through brands.

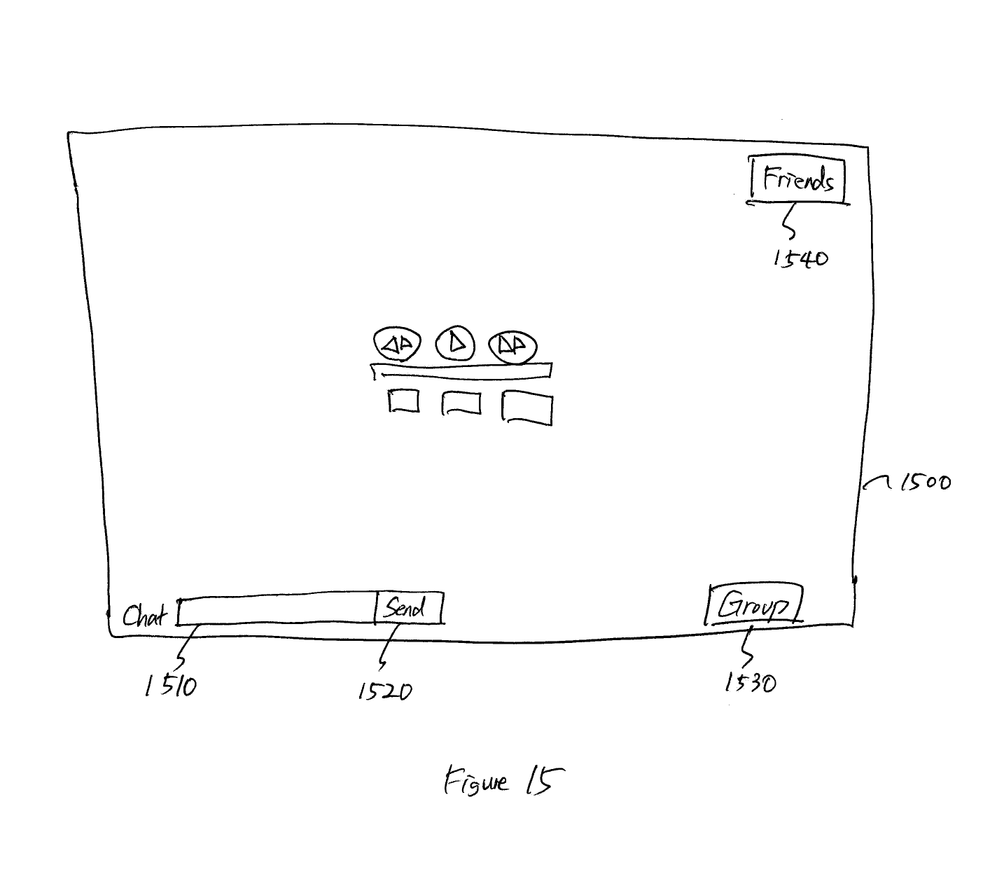

FIGS. 14A and 14B illustrate an exemplary display screen of a computing device, showing branded backgrounds through a digital media player according to exemplary embodiments. The displays of FIGS. 14A and 14B depict branded backgrounds which comprise multiple branded content items that are simultaneously displayed. In the event the server 110 finds that multiple branded content items should be paired with a media content item, the digital media player can optionally be configured to simultaneously display a plurality of the branded content items. For example, if the song's lyrics often mention “beer”, then the server 110 can be configured to search the brand database 124 and find a plurality of branded content items related to “beer” advertisements such as beer Brands A, B, and C. In such a case, the server 110 can pair multiple branded contents with the media content. FIG. 14A shows a display of a branded background which comprises two branded contents in horizontally divided frames. FIG. 14B shows a display of a branded background which comprises three branded contents in vertically divided frames. It should be understood that multiple branded contents can be presented in a variety of different ways. For example, the computing device 150 can be configured to display a slideshow of more than one branded content as a brand background of a brandable media format. In this embodiment, any time interval can be set to trigger the computing device 150 to display the next slide (branded content) to the user 180.

FIG. 15 illustrates an exemplary display screen of a computing device, showing a user interface for chatting according to one embodiment of the present invention. The display 1500 of FIG. 15 provides additional features to the display 500 of FIG. 5A or the display 1000 of FIG. 10. The display 1500 may include a “Chat” field 1510, a “Send Media” button 1520, a “Group” link 1530, and a “Friends” link 1540.

In operation, the “Chat” field 1510 provides the user 180 a chat feature, which allows the user 180 to chat with any other user who is also registered with the server 110 and preferably who is currently logged in to the server 110. The user 180 can use a “Chat” field 1510 to type in words or sentences to generate a message that is going to be sent to other users. Additionally, the user 180 can send a brandable media format, either the one in the user's playlist or the one currently being played by the user 180, to a chatting partner by clicking the “Send” button 1520. The computing device 150 is configured to transmit the chosen brandable media format to a chatting partner.

The “Group” link 1530 represents a group of users who may possess similar or same interest as that of the user 180. As explained in FIG. 4, users of the present system can be grouped based on several factors. For example, users who share same “Tastes” for music (e.g., Rock), may be grouped together. In this instance, the computing device 150 is configured to generate a list of users whose profiles share same description as to the “Tastes” field (e.g., “Rock”) of the user information database 120 when the user 180 clicks the “Group” link 1530. Another example would be that users who live in the same region may be grouped together. In this instance, the computing device 150 is configured to generate a list of users whose profiles share same description as to the “zip code” field (e.g., 63111) of the user information database 120 when the user 180 clicks the “Group link 1530. Furthermore, the computing device 150 can be configured to group users who are currently playing the same media content automatically. The user 180 can freely choose another user in the list provided by the computing device 150 and chat with that person by clicking on the name of that person. This allows the user 180 to share his or her musical interest with someone who is likely to possess similar or same musical tastes. Alternatively, the information with respect to which group of users share common musical interest can be purchased by the brand owners 170 (or alternatively the content owner 160) so that they can selectively target a particular group of users who are likely to be interested in a particular branded content uploaded by the brand owners 170 (or alternatively a particular media content uploaded by the content owner 160). Furthermore, the user 180 can register a friend with any user who has chatted with the user 180 or someone who has shared a branded media format with the user 180 through one of social networking websites. The “Friends” link 1540 represents users those who are registered with the user 180 as a friend. By clicking the “Friends” field 1540, the user 180 can see a list of the registered friends and further can select other person from that list to chat with.

While the present invention has been described above in relation to exemplary embodiments, various modifications may be made thereto that still fall within the invention's scope, as would be recognized by those of ordinary skill in the art. Such modifications to the invention will be recognizable upon review of the teachings herein.

Sample claims of various inventive aspects of the disclosed invention, not to be considered as exhaustive or limiting, all of which are fully described so as to satisfy the written description, enablement, and best mode requirement of the Patent Laws, are as follows:

What is claimed is:

1. A method for pairing media content with branded content, the method comprising:
storing a media content item in a memory, the media content item configured to be played for a user via a digital media player, the media content item comprising (1) playable media content configured for playback to a user, and (2) metadata about the playable media content;
determining a branded content item for pairing with the playable media content based on the metadata;
playing the playable media content via the digital media player; and
playing the determined branded content via the digital media player without interrupting the playing of the playable media content; and
wherein the method steps are performed by a processor.

2. The method of claim 1 wherein the metadata includes an image associated with the media content item, wherein the digital media player includes a visual display capability, and wherein the branded content playing step comprises:
while the playable media content is playing through the digital media player, displaying the determined branded content item via the visual display capability of the digital media player such that the visual display capability alternates between a display of the image and a display of the branded content item.

3. The method of claim 2 wherein the third party branded content item comprises an advertisement.

4. The method of claim 3 wherein the advertisement comprises an advertisement image configured as a puzzle, the puzzle comprising a plurality of advertisement image portions that are initially presented in a puzzled format through the visual display capability of the digital media player, and wherein the digital media player is configured to receive user input for moving the advertisement image portions into an unpuzzled format.

5. The method of claim 2 further comprising:
receiving a selection from the user to play the playable media content; and
performing the determining step after the selection receiving step.

6. The method of claim 2 further comprising:
repeating the determining step and the displaying step a plurality of times while the playable media content is playing through the digital media player, wherein the repeating step causes a plurality of different branded content items to be displayed through the visual display capability while the playable media content is playing through the digital media player.

7. The method of claim 2 wherein the displaying step comprises, while the playable media content is playing through the digital media player, displaying the determined branded content item via the visual display capability of the digital media player such that the visual display capability alternates between a display of the image and a display of the branded content item on a timed basis.

8. The method of claim 2 further comprising:
analyzing the playable media content to determine a characteristic of the playable media content; and
wherein the displaying step comprises, while the playable media content is playing through the digital media player, displaying the determined branded content item via the visual display capability of the digital media player such that the visual display capability alternates between a display of the image and a display of the branded content item based on the determined characteristic.

9. The method of claim 1 wherein the playable media content comprises a musical work, wherein the metadata further comprises lyrics for the musical work, the method further comprising:
storing a plurality of branded content items in a memory; and
maintaining a plurality of associations between the branded content items and a plurality of keywords;
processing the lyrics to determine whether any of the lyrics are deemed matches to any of the keywords; and
wherein the determining step comprises selecting a branded content item from the plurality of branded content items based on an association between at least one branded content item and at least one keyword deemed a match to the processed lyrics.

10. The method of claim 1 further comprising:
storing a plurality of branded content items in a memory;
maintaining a plurality of associations between the branded content items and data indicative of a plurality of geographical areas;
determining a geographic location for the digital media player; and
wherein the third party branded content item determining step comprises selecting a branded content item from the plurality of branded content items based on which of the branded content items are associated with data indicative of a geographic area within which the determined geographic location is located.

11. The method of claim 1 further comprising:
storing a plurality of branded content items in a memory;
maintaining a plurality of associations between the branded content items and data indicative of a plurality of times of day;
determining a current local time for the digital media player; and
wherein the third party branded content item determining step comprises selecting a branded content item from the plurality of branded content items based on which of the branded content items are associated with data indicative of a time of day to which the determined current local time belongs.

12. The method of claim 1 wherein the branded content item comprises a game, and wherein the digital media player is configured to play the game in response to user input while the playable media content is playing through the digital media player.

13. The method of claim 1 wherein the branded content item comprises audio branded content, and wherein the media content item comprises a video work.

14. The method of claim 1 wherein the processor comprises a plurality of processors, and wherein at least one of the processors is resident in a digital advertising panel, the at least one processor being configured to execute the digital media player.

15. A media content product comprising:
a computer-readable data structure that is resident on a non-transitory computer-readable storage medium, the data structure comprising (1) media content configured for playback through a digital media player, (2) metadata about the media content, the metadata including an image, and (3) executable program code configured, upon execution, to (i) call a remote server over a network, (ii) receive a branded content item from the remote server in response to the call, and (iii) cause the digital media player to visually display, during a playback of the media content, the image and the branded content item in an alternating sequence.

16. A system for pairing media content with branded content, the system comprising:
a memory; and
a server for access over a network by a plurality of remote computers, the server configured to provide a plurality of interfaces for the remote computers to the memory, the interfaces including:
a media content source interface, the media content source interface configured to receive (i) a plurality of media content items, (ii) metadata about the media content items, and (iii) a plurality of branding criteria for association with the media content items from a plurality of media content sources via a plurality of the remote computers;
a branded content source interface, the branded content source interface configured to receive (i) a plurality of branded content items and (ii) a plurality of brand targeting criteria from a plurality of branded content sources via a plurality of the remote computers;
wherein the server is further configured to store the received media content items in the memory in association with (i) data indicative of their respective media content sources, (ii) their respective received metadata, and (iii) their respective branding criteria;
wherein the server is further configured to store the received branded content items in the memory in association with (i) data indicative of their respective branded content sources, (ii) their respective brand targeting criteria; and
wherein the server is further configured to associate a plurality of the media content items in the memory with a plurality of the branded content items in the memory based on a correspondence between the branding criteria associated with the media content items and the brand targeting criteria associated with the branded content items.

17. The system of claim 16 wherein the interfaces further include a media content consumer interface, the media content consumer interface configured to receive a plurality of requests for a plurality of media content items in the memory from a plurality of media content consumers via a plurality of the remote computers; and
wherein the server is further configured to respond to the requests by communicating (i) the media content items corresponding to the requests and (ii) a branded content items associated with media content items corresponding to the requests to the respective remote computers that sent the requests for playback of the communicated media content items while the communicated branded content items are also displayed.

18. The system of claim 17 wherein the media content consumer interface is further configured to permit the media content consumers to search the memory for specific media content items.

19. The system of claim 17 wherein the media content consumer interface is further configured to permit the media content consumers to search the memory for specific branded content items.

20. The system of claim 16 wherein the media content source interface is further configured to receive branding revenue sharing criteria from the media content sources for defining how revenue generated from branding of media content items is to be shared with each media content source.

21. The system of claim 16 wherein the media content items comprise a plurality of musical works, and wherein the branded content items comprise a plurality of advertisements.

22. The system of claim 16 wherein the branding criteria comprises a plurality of branding prohibitions.

23. The system of claim 16 wherein the media content source interface is further configured to receive control instructions for selectively enabling and disabling branding of selected media content items from the media content sources, and wherein the server is further configured to enforce the control instructions when associating media content items with branded content items.

24. The system of claim 16 wherein the brand targeting criteria further comprises:
a plurality of desired audience demographic parameters with respect to at least one branded content item;
a plurality of parameters for defining an advertising campaign size with respect to at least one branded content item; and
a temporal period for at least one branded content item.

25. The system of claim 16 wherein the server is further configured to administer an auction of a branding right for a media content item wherein a plurality of bids for branding rights with respect the media content item are processed from a plurality of branded content sources.

26. A method comprising:
receiving a plurality of bids associated with a plurality of branded content items for a branding right with respect to a media content item;
processing bids to identify a winning bid; and
creating a pairing association between the branded content item associated with the winning bid and the media content item such that the branded content item associated with the winning bid will be presented to a plurality of consumers when the media content item is consumed by the consumers; and
wherein the method steps are performed by a processor.
